(19) United States
(12) Patent Application Publication
(10) Pub. No.: US 2020/0279185 A1
(43) Pub. Date: Sep. 3, 2020

(54) QUANTUM RELATIVE ENTROPY TRAINING OF BOLTZMANN MACHINES

(71) Applicant: Microsoft Technology Licensing, LLC, Redmond, WA (US)

(72) Inventors: Nathan O. WIEBE, Seattle, WA (US); Leonard Peter WOSSNIG, Kissing (DE)

(73) Assignee: Microsoft Technology Licensing, LLC, Redmond, WA (US)

(21) Appl. No.: 16/289,417

(22) Filed: Feb. 28, 2019

(51) Int. Cl. G06N 10/00; G06N 3/04; G06F 17/18; G06N 3/08

(52) U.S. Cl. CPC G06N 10/00; G06N 3/08; G06F 17/18; G06N 3/0472

(57) ABSTRACT

Methods to train a quantum Boltzmann machine (QBM) having one or more visible nodes and one or more hidden nodes. The methods comprise associating each visible and each hidden node of the QBM to a different corresponding qubit of a plurality of qubits of a quantum computer, wherein a state of each of the plurality of qubits contributes to a global energy of the QBM according to a set of weighting factors, and wherein the plurality of qubits include one or more output qubits corresponding to one or more visible nodes of the QBM. The methods further comprise providing a distribution of training data over the one or more output qubits, estimating a gradient of a quantum relative entropy between the output qubits and the distribution of training data, and training the set of weighting factors based on the estimated gradient using the quantum relative entropy as a cost function.

### BACKGROUND

A quantum computer is a physical machine configured to execute logical operations based on or influenced by quantum-mechanical phenomena. Such logical operations may include, for example, mathematical computation. Current interest in quantum-computer technology is motivated by theoretical analysis suggesting that the computational efficiency of an appropriately configured quantum computer may surpass that of any practicable non-quantum computer when applied to certain types of problems. Such problems include, for example, integer factorization, data searching, computer modeling of quantum phenomena, function optimization including machine learning, and solution of systems of linear equations. Moreover, it has been predicted that continued miniaturization of conventional computer logic structures will ultimately lead to the development of nanoscale logic components that exhibit quantum effects, and must therefore be addressed according to quantum-computing principles.

In the application of quantum computers to neural networks, various challenges persist as to the manner in which a quantum neural network may be trained to a desired task. In classical neural-network training, parametric weights and thresholds are optimized according to the gradient of a cost function evaluated over the domain of neuron states. For quantum neural networks, however, the gradient of the cost function may be difficult to estimate due to operator non-commutivity and other analytical complexities.

### SUMMARY

This disclosure describes, inter alia, methods to train a quantum Boltzmann machine (QBM) having one or more visible nodes and one or more hidden nodes. The methods comprise associating each visible and each hidden node of the QBM to a different corresponding qubit of a plurality of qubits of a quantum computer, wherein a state of each of the plurality of qubits contributes to a global energy of the QBM according to a set of weighting factors, and wherein the plurality of qubits include one or more output qubits corresponding to one or more visible nodes of the QBM. The methods further comprise providing a distribution of training data over the one or more output qubits, estimating a gradient of a quantum relative entropy between the one or more output qubits and the distribution of training data, and training the set of weighting factors based on the estimated gradient, using the quantum relative entropy as a cost function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example quantum computer.

FIG. 2 illustrates a Bloch sphere, which graphically represents the quantum state of one qubit of a quantum computer.

FIG. 3 shows aspects of an example signal waveform for effecting a quantum-gate operation in a quantum computer.

FIG. 4A shows aspects of an example Boltzmann machine.

FIG. 4B shows aspects of an example restricted Boltzmann machine.

FIG. 5 illustrates an example method to train a quantum Boltzmann machine having visible and hidden nodes.

FIGS. 6A and 6B illustrate an example method to estimate the gradient of the quantum relative entropy of a restricted quantum Boltzmann machine having visible and hidden nodes.

FIG. 7 illustrates an example method to estimate the gradient of the quantum relative entropy of a restricted or non-restricted quantum Boltzmann machine.

### DETAILED DESCRIPTION

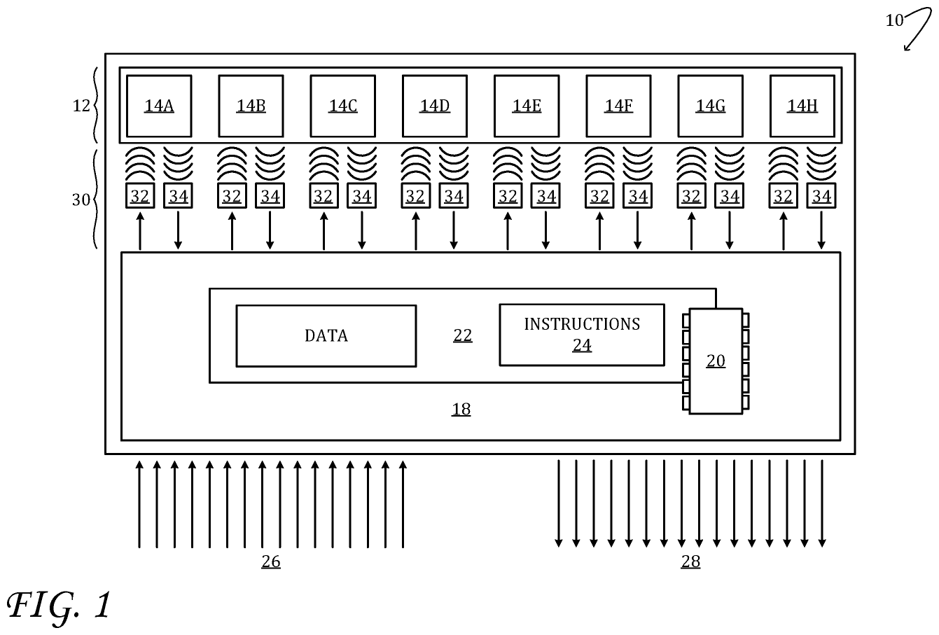

FIG. 1 shows aspects of an example quantum computer 10 configured to execute quantum-logic operations (vide infra). Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 10 of FIG. 1 includes at least one qubit register 12 comprising an array of qubits 14. The illustrated qubit register is eight qubits in length; qubit registers comprising longer and shorter qubit arrays are also envisaged, as are quantum computers comprising two or more qubit registers of any length.

Qubits 14 of qubit register 12 may take various forms, depending on the desired architecture of quantum computer 10. Each qubit may comprise: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. More generally, each qubit 14 may comprise any particle or system of particles that can exist in two or more discrete quantum states that can be measured and manipulated experimentally. For instance, a qubit may be implemented in the plural processing states corresponding to different modes of light propagation through linear optical elements (e.g., mirrors, beam splitters and phase shifters), as well as in states accumulated within a Bose-Einstein condensate.

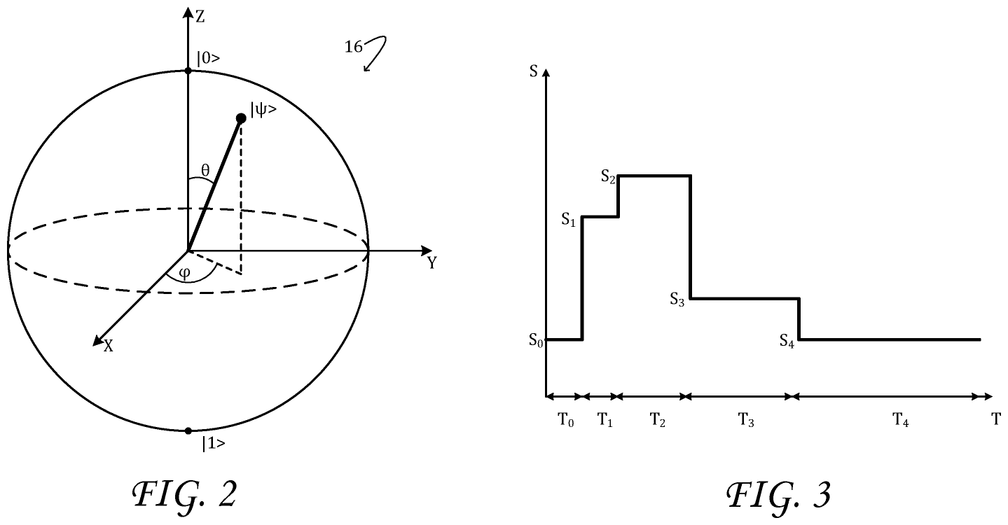

FIG. 2 is an illustration of a Bloch sphere 16, which provides a graphical description of some quantum mechanical aspects of an individual qubit 14. In this description, the north and south poles of the Bloch sphere correspond to the standard basis vectors |0 [symbol] and |1 [symbol] , respectively up and down spin states, for example, of an electron or other fermion. The set of points on the surface of the Bloch sphere comprise all possible pure states |ψ [symbol] of the qubit, while the interior points correspond to all possible mixed states. A mixed state of a given qubit may result from decoherence, which may occur because of undesirable coupling to external degrees of freedom.

Returning now to FIG. 1, quantum computer 10 includes a controller 18. The controller may include at least one processor 20 and associated computer memory 22. A processor 20 of controller 18 may be coupled operatively to peripheral componentry, such as network componentry, to enable the quantum computer to be operated remotely. A processor 20 of controller 18 may take the form of a central processing unit (CPU), a graphics processing unit (GPU), or the like. As such, the controller may comprise classical electronic componentry. The term ‘classical’ is applied herein to any component that can be modeled accurately as an ensemble of particles without considering the quantum state of any individual particle. Classical electronic components include integrated, microlithographed transistors, resistors, and capacitors, for example. Computer memory 22 may be configured to hold program instructions 24 that cause processor 20 to execute any function or process of the controller. In examples in which qubit register 12 is a low-temperature or cryogenic device, controller 18 may include control componentry operable at low or cryogenic temperatures—e.g., a field-programmable gate array (FPGA) operated at 77K. In such examples, the low-temperature control componentry may be coupled operatively to interface componentry operable at normal temperatures.

Controller 18 of quantum computer 10 is configured to receive a plurality of inputs 26 and to provide a plurality of outputs 28. The inputs and outputs may each comprise digital and/or analog lines. At least some of the inputs and outputs may be data lines through which data is provided to and extracted from the quantum computer. Other inputs may comprise control lines via which the operation of the quantum computer may be adjusted or otherwise controlled.

Controller 18 is operatively coupled to qubit register 12 via quantum interface 30. The quantum interface is configured to exchange data bidirectionally with the controller. The quantum interface is further configured to exchange signal corresponding to the data bidirectionally with the qubit register. Depending on the architecture of quantum computer 10, such signal may include electrical, magnetic, and/or optical signal. Via signal conveyed through the quantum interface, the controller may interrogate and otherwise influence the quantum state held in the qubit register, as defined by the collective quantum state of the array of qubits 14. To this end, the quantum interface includes at least one modulator 32 and at least one demodulator 34, each coupled operatively to one or more qubits of the qubit register. Each modulator is configured to output a signal to the qubit register based on modulation data received from the controller. Each demodulator is configured to sense a signal from the qubit register and to output data to the controller based on the signal. The data received from the demodulator may, in some examples, be an estimate of an observable to the measurement of the quantum state held in the qubit register.

In some examples, suitably configured signal from modulator 32 may interact physically with one or more qubits 14 of qubit register 12 to trigger measurement of the quantum state held in one or more qubits. Demodulator 34 may then sense a resulting signal released by the one or more qubits pursuant to the measurement, and may furnish the data corresponding to the resulting signal to the controller. Stated another way, the demodulator may be configured to output, based on the signal received, an estimate of one or more observables reflecting the quantum state of one or more qubits of the qubit register, and to furnish the estimate to controller 18. In one non-limiting example, the modulator may provide, based on data from the controller, an appropriate voltage pulse or pulse train to an electrode of one or more qubits, to initiate a measurement. In short order, the demodulator may sense photon emission from the one or more qubits and may assert a corresponding digital voltage level on a quantum-interface line into the controller. Generally speaking, any measurement of a quantum-mechanical state is defined by the operator O corresponding to the observable to be measured; the result R of the measurement is guaranteed to be one of the allowed eigenvalues of O. In quantum computer 10, R is statistically related to the qubit-register state prior to the measurement, but is not uniquely determined by the qubit-register state.

Pursuant to appropriate input from controller 18, quantum interface 30 may be configured to implement one or more quantum-logic gates to operate on the quantum state held in qubit register 12. Whereas the function of each type of logic gate of a classical computer system is described according to a corresponding truth table, the function of each type of quantum gate is described by a corresponding operator matrix. The operator matrix operates on (i.e., multiplies) the complex vector representing the qubit register state and effects a specified rotation of that vector in Hilbert space.

For example, the Hadamard gate H is defined by

$$H = \frac{1}{\sqrt{2}} [ \begin{matrix}1 & 1 \\ 1 & - 1\end{matrix} ] \qquad ( 1 )$$

The H gate acts on a single qubit; it maps the basis state |0 [symbol] to (|0 [symbol] +|1 [symbol] )/\sqrt{2}, and maps |1 [symbol] to (|0 [symbol] −|1 [symbol] )/\sqrt{2}. Accordingly, the H gate creates a superposition of states that, when measured, have equal probability of revealing |0 [symbol] or |1 [symbol] .

The phase gate S is defined by

$$S = [ \begin{matrix}1 & 0 \\ 0 & {e}^{i π \text{/} 2}\end{matrix} ] . \qquad ( 2 )$$

The S gate leaves the basis state |0 [symbol] unchanged but maps |1 [symbol] to e^{iπ/2}|1 [symbol] . Accordingly, the probability of measuring either |0 [symbol] or |1 [symbol] is unchanged by this gate, but the phase of the quantum state of the qubit is shifted. This is equivalent to rotating ψ by 90 degrees along a circle of latitude on the Bloch sphere of FIG. 2.

Some quantum gates operate on two or more qubits. The SWAP gate, for example, acts on two distinct qubits and swaps their values. This gate is defined by

$$SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] . \qquad ( 3 )$$

The foregoing list of quantum gates and associated operator matrices is non-exhaustive, but is provided for ease of illustration. Other quantum gates include Pauli-X, -Y, and -Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

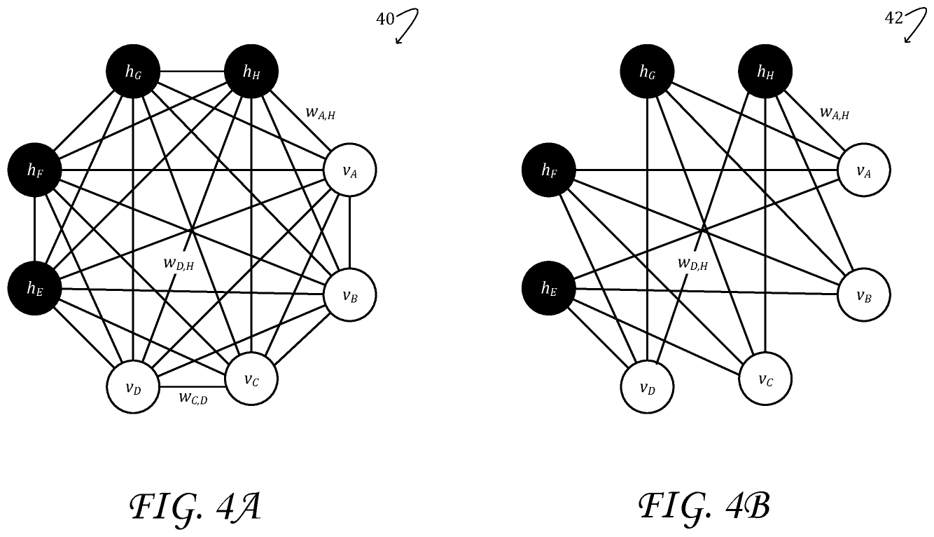

Continuing in FIG. 1, suitably configured signal from modulators 32 of quantum interface 30 may interact physically with one or more qubits 14 of qubit register 12 so as to assert any desired quantum-gate operation. As noted above, the desired quantum-gate operations are specifically defined rotations of a complex vector representing the qubit register state. In order to effect a desired rotation O, one or more modulators of quantum interface 30 may apply a predetermined signal level Sᵢ for a predetermined duration Tᵢ. In some examples, plural signal levels may be applied for plural sequenced or otherwise associated durations, as shown in FIG. 3, to assert a quantum-gate operation on one or more qubits of the qubit register. In general, each signal level Sᵢ and each duration Tᵢ is a control parameter adjustable by appropriate programming of controller 18.

The term ‘oracle’ is used herein to describe a predetermined sequence of elementary quantum-gate and/or measurement operations executable by quantum computer 10. An oracle may be used to transform the quantum state of qubit register 12 to effect a classical or non-elementary quantum-gate operation or to apply a density operator, for example. In some examples, an oracle may be used to enact a predefined ‘black-box’ operation ƒ(x), which may be incorporated in a complex sequence of operations. To ensure adjoint operation, an oracle mapping n input qubits |x [symbol] to m output or ancilla qubits |y=ƒ(x)) may be defined as a quantum gate O(|x [symbol] ⊗|y [symbol] ) operating on the (n+m) qubits. In this case, O may be configured to pass the n input qubits unchanged but combine the result of the operation ƒ(x) with the ancillary qubits via an XOR operation, such that O(|x) [symbol] ⊗|y [symbol] )=|x [symbol] ⊗|y ⊗ƒ(x) [symbol] . As described further below, a Gibbs-state oracle is an oracle configured to generate a Gibbs state based on a quantum state of specified qubit length.

Implicit in the description herein is that each qubit 14 of qubit register 12 may be interrogated via quantum interface 30 so as to reveal with confidence the standard basis vector |0 [symbol] or |1 [symbol] that characterizes the quantum state of that qubit. In some implementations, however, measurement of the quantum state of a physical qubit may be subject to error. Accordingly, any qubit 14 may be implemented as a logical qubit, which includes a grouping of physical qubits measured according to an error-correcting oracle that reveals the quantum state of the logical qubit with confidence.

Within the last several years, quantum machine learning has emerged as a significant motivation for developing quantum computers. In theory, quantum computers are naturally poised to model various real-world problems to which classical models are difficult to apply. Relative to the analogous classical model, a quantum model may be more accurate, more private, or faster to train, for example. Significantly, quantum computers may be capable of modeling probability distributions that, when represented by classical models, cannot be sampled efficiently. This ability may provide a broader or richer family of distributions than could be realized using a polynomial-sized classical model.

Many examples in which quantum machine learning may provide such advantages involve data having inherently quantum features, e.g., physical, chemical, and/or biological data. A quantum machine-learning dataset may include inter-atomic energy potentials, molecular atomization energy data, polarization data, molecular orbital eigenvalue data, protein or nucleic-acid folding data, etc. In some examples, quantum machine learning models may be suitable for simulating, evaluating, and/or designing physical quantum systems. For example, quantum machine learning models may be used to predict behavior of nanomaterials (e.g., quantum dot charge states, quantum circuitry, and the like). In some examples, quantum machine learning models may be suitable for tomography and/or partial tomography of quantum systems, e.g., approximately cloning an oracle system represented by an unknown density operator. Numerous other examples are equally envisaged.

Classical data is traditionally fed to a quantum algorithm in the form of a training set, or test set, of vectors. But rather than train on individual vectors, as one does in classical machine learning, quantum machine learning provides an opportunity to train on quantum-state vectors. More specifically, if the classical training set is thought of as a distribution over input vectors, then the analogous quantum training set would be a density operator, denoted ρ, which operates on the global quantum state of the network.

The goals in quantum machine learning vary from task to task. For unsupervised generative tasks, a common goal is to find, by experimenting with ρ, a process V such that V:|0 [symbol] [symbol] σ such that ∥ρ−σ∥ is small. Such a task corresponds, in quantum information language, to partial tomography or approximate cloning. Alternatively, supervised learning tasks are possible, in which the task is not to replicate the distribution but rather to replicate the conditional probability distributions over a label subspace. This approach is frequently taken in QAOA-based quantum neural networks.

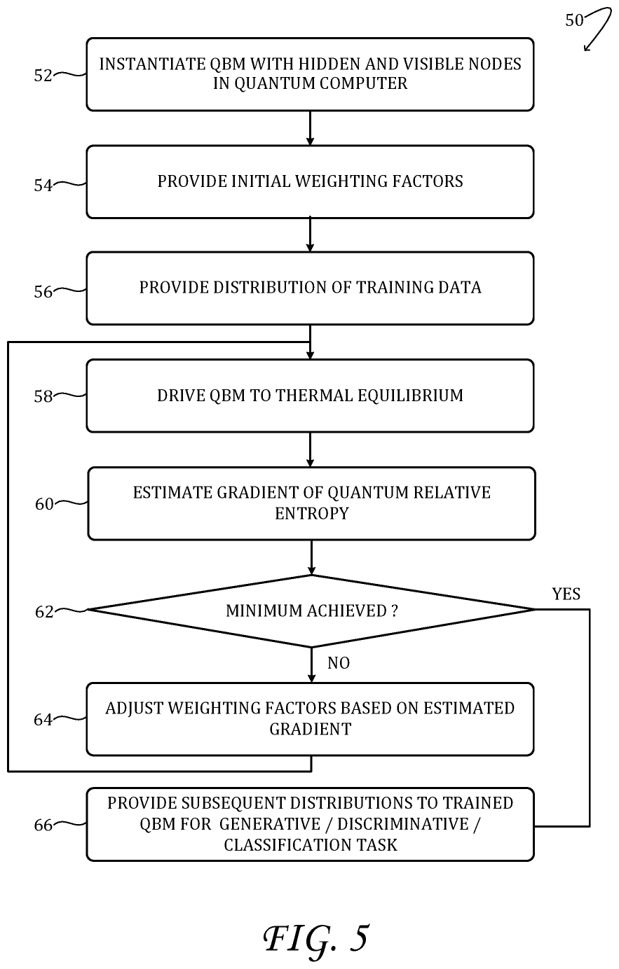

In recent years, quantum Boltzmann machines have emerged as one of the most promising architectures for quantum neural networks. So that the reader can more easily understand the function of the quantum Boltzmann machine, the classical variant of the Boltzmann machine will first be described, with reference to FIGS. 4A and 4B. The skilled reader will understand that some but not all aspects of this description are relevant also to the quantum variant, which is further described hereinafter.

FIG. 4A shows aspects of a Boltzmann machine 40, in one example. Every Boltzmann machine includes one or more of visible nodes vᵢ and may also include one or more hidden nodes hᵢ. The term ‘unit’ may also be used to refer to a node of a Boltzmann machine; these terms are used interchangeably herein. Only the visible nodes receive data from outside the Boltzmann machine. While FIG. 4A shows four visible and four hidden nodes, other combinations of visible and hidden nodes are also envisaged, and certainly the numbers of visible and hidden nodes need not be equal. Each visible node vᵢ and each hidden node hᵢ of classical Boltzmann machine 40 is characterized by a state variable sᵢ, which may have a value of 0 or 1. The collective states of the visible and hidden nodes are expressible, therefore, as a binary vectors v and h, respectively.

Collectively, the {sᵢ} determines the global energy E of classical Boltzmann machine 40, according to

$$- E = {\sum }_{i < j} {w}_{ij} {s}_{i} {s}_{j} + {\sum }_{i} {θ}_{i} {s}_{i} , \qquad ( 4 )$$

where each θᵢ defines the bias of sᵢ on the energy, and each wᵢⱼ defines the weight of an additional energy of interaction, or ‘connection strength’, between nodes i and j.

During operation of Boltzmann machine 40, the equilibrium state is approached by resetting the state variable sᵢ of each of a sequence of randomly selected nodes according to a statistical rule. The rule for a classical Boltzmann machine is that the ensemble of nodes adheres to the Boltzmann distribution of statistical mechanics. In other words,

$$Δ {E}_{i} = - {k}_{B} T ln \frac{{p}_{{s}_{i} = 0}}{{p}_{{s}_{i} = 1}} , \qquad ( 5 )$$

where pₛ_{ᵢ}₌₀ and pₛ_{ᵢ}₌₁ express the probabilities that sᵢ=0 or 1, respectively, where ΔEᵢ is the change in the energy E of the ensemble of nodes due to the transition of the single node i from the sᵢ=0 to the sᵢ=1 state, where k_{B} is a constant, and where T is an adjustable parameter akin to the ‘temperature’ of the system. The reader will note that ΔEᵢ is readily obtained from Eq 4, above. Substituting pₛ_{ᵢ}₌₀=1−pₛ_{ᵢ}₌₁, the logistic function for the classical Boltzmann machine is obtained,

$${p}_{{s}_{i} = 1} = \frac{1}{1 + {e}^{- Δ {E}_{i} \text{/} T}} . \qquad ( 6 )$$

After a sufficient number of iterations at a predetermined T, the probability of observing any global state {sᵢ} will depend only upon the energy of that state, not on the initial state from which the process was started. At that limit, the Boltzmann machine has achieved ‘thermal equilibrium’ at temperature T. In the optional method of ‘simulated annealing’, T is gradually transitioned from higher to lower values during the approach to equilibrium, in order to increase the likelihood of descending to a global energy minimum.

In useful examples, a Boltzmann machine is trained to converge to one or more desired global states using an external training distribution over such states. During the training, biases θᵢ and weights wᵢⱼ are adjusted so that the global states with the highest probabilities have the lowest energies. To illustrate the training method, let P⁺(v) be a distribution of training data over the vector of visible nodes v, and let P⁻(v) be a distribution of thermally equilibrated states of the Boltzmann machine, which have been ‘marginalized’ over the hidden nodes of the machine. An appropriate measure of the dissimilarity of the two distributions is the Kullback-Leibler (KL) divergence G, defined as

$$G = {\sum }_{v} {P}^{+} ( v ) ln \frac{{P}^{+} ( v )}{{P}^{-} ( v )} , \qquad ( 7 )$$

where the sum is over all possible states v of v. In practice, a Boltzmann machine may be trained in two alternating phases: a ‘positive’ phase in which v is constrained to one particular binary state vector sampled from the training set (according to P+(v)), and a ‘negative’ phase in which the network is allowed to run freely. In this approach, the gradient with respect to a given weight, wᵢⱼ is given by

$$\frac{\partial G}{\partial {w}_{ij}} = - \frac{{p}_{ij}^{+} - {p}_{ij}^{-}}{R} , \qquad ( 8 )$$

where pᵢⱼ⁺ is the probability that sᵢ=sⱼ=1 at thermal equilibrium of the positive phase, pᵢⱼ⁻ is the probability that sᵢ=sⱼ=1 at thermal equilibrium of the negative phase, and where R is a learning-rate parameter. Finally, the biases are trained according to

$$\frac{\partial G}{\partial {θ}_{i}} = - \frac{{p}_{i}^{+} - {p}_{i}^{-}}{R} . \qquad ( 9 )$$

An important variant of the Boltzmann machine is the ‘restricted’ Boltzman machine (RBM). An example RBM 42 is represented in FIG. 4B. An RBM differs from a generic Boltzmann machine in that it has no connection (wᵢⱼ=0) between any pair of hidden nodes or any pair of visible nodes. Relative to the generic classical Boltzmann machine, the classical RBM is more easily trained and is applicable to a ‘deep-learning’ strategy in which the hidden nodes of a trained, upstream RBM are used to provide training data for training an adjacent downstream RBM, in a stacked, multilayer configuration.

Returning briefly to FIG. 1, quantum computer 10 may be configured to instantiate a quantum-computing analog of the classical Boltzmann machine, which is referred to herein as a quantum Boltzmann machine (QBM). The state {sᵢ} of the visible and hidden nodes of a QBM may be represented in the array of qubits 14 of qubit register 12. For example, the state of four visible nodes of a QBM may be represented in qubits 14A through 14D, and the state of four hidden nodes of the QBM may be represented in qubits 14E through 14H. In other examples, qubit register 12 may include, in addition to qubits corresponding to the visible and hidden nodes, one or more ‘ancilla’ qubits used to transiently store quantum states derived from the states of the visible and hidden nodes e.g., to implement an oracle. Naturally, any physical register of two or more qubits is divisible, as well as associable, so as to form any number of logical qubit registers visible, hidden, and ancilla registers, for example. The skilled reader will understand that a qubit register may be referred to as a ‘register’ in the description below.

Boltzmann machines are extensible to the quantum domain because they approximate the physics inherent in a quantum computer. In particular, a Boltzmann machine provides an energy for every configuration of a system and generates samples from the distribution of configurations with probabilities that depend exponentially on the energy. The same would be expected of a canonical ensemble in statistical physics. The explicit model in this case is

$${σ}_{v} = {Tr}_{h} ( \frac{{e}^{- H}}{Z} ) , \qquad ( 10 )$$

where Trₕ(⋅) is the partial trace over an auxiliary subsystem known as the hidden subsystem, which serves to build correlations between nodes of the visible subsystem. Thus, the goal of generative quantum Boltzmann training is to choose σᵥ=argmin_{H} (dist(ρ, σᵥ)) for an appropriate distance, or divergence, function. In this disclosure, the terms ‘loss function’, ‘cost function’, and ‘divergence function’ are used interchangeably.

The goal in training a QBM is to find a Hamiltonian that replicates a given input state as closely as possible. This is useful not only in generative applications, but can also be used for discriminative tasks by defining the visible unit subsystem to be composed of the tensor products of a visible subsystem and an output layer that yields the classification of the system. While generative tasks are the main focus here, it is straightforward to generalize this work to classification.

As noted above, for generative training on classical data, the natural divergence between the input and output distributions is the KL divergence. When the input is a quantum state, however, the quantum relative entropy is an appropriate measure of the divergence:

S(ρ|σᵥ)=Tr(ρ log ρ)−Tr(ρ log σᵥ). (11)

The skilled reader will note that Eq. 11 reduces to the KL divergence if ρ and σᵥ are classical. Moreover, S becomes zero if and only if ρ=σᵥ.

While quantum relative entropy is generally difficult to compute, the gradient of the quantum relative entropy is readily available for QBMs with all visible units. In such cases, σᵥ=e^{-H}/Z. Further, the relation log(e^{-H}/Z)=−H−log(Z) allows straightforward computation of the required matrix derivatives. On the other hand, no methods are known prior to this disclosure for generative training of QBMs using quantum relative entropy as a loss function when hidden units are present. This is because the partial trace in log(Trₕe^{-H}/Z) prevents simplification of the logarithm term when computing the gradient.

The purpose of this disclosure is to provide practical methods for training generic QBMs that have hidden as well as visible units. Two variants are disclosed herein. The first and more efficient approach assumes a special form for the Hamiltonian, from which variational upper bounds on the quantum relative entropy are found, with an easy-to-compute derivatives. More specifically, the Hamiltonian acting on the hidden units commutes in this approach, such that the relevant gradients can be computed using a polynomial number of queries to a coherent Gibbs-state oracle. The second and more general approach uses recent techniques from quantum simulation to approximate the exact expression for the gradient of the relative entropy using Fourier-series approximations and high-order divided-difference formulas in place of the analytic derivative. Here, the exact gradient is computed using a polynomial (albeit greater) number of queries. Both methods are efficient provided that Gibbs-state preparation is efficient, which is expected to hold in most practical cases of Boltzmann training (although it is worth noting that efficient Gibbs-state preparation in general would imply QMA⊂BQP, which is unlikely to hold).

The interested reader is referred to the following list of references, which are cited below and hereby incorporated by reference herein.
[1] L D Landau and E M Lifshitz. Statistical physics, vol. 5. Course of theoretical physics, 30, 1980.
[2] Maria Kieferova and Nathan Wiebe. Tomography and generative data modeling via quantum boltzmann training. arXiv preprint arXiv:1612.05204, 2016.
[3] Joran Van Apeldoorn, Andras Gilyén, Sander Gribling, and Ronald de Wolf. Quantum sdp-solvers: Better upper and lower bounds. In Foundations of Computer Science (FOCS), 2017 IEEE 58th Annual Symposium on, pages 403-414. IEEE, 2017.
[4] David Poulin and Pawel Wocjan. Sampling from the thermal quantum gibbs state and evaluating partition functions with a quantum computer. Physical review letters, 103(22):220502, 2009.
[5] Seth Lloyd, Masoud Mohseni, and Patrick Rebentrost. Quantum principal component analysis. Nature Physics, 10(9):631, 2014.
[6] Shelby Kimmel, Cedric Yen-Yu Lin, Guang Hao Low, Maris Ozols, and Theodore J Yoder. Hamiltonian simulation with optimal sample complexity. npj Quantum Information, 3(1):13, 2017.
[7] Howard E Haber. Notes on the matrix exponential and logarithm. 2018.
[8] Nicholas J Higham. Functions of matrices: theory and computation, volume 104. Siam, 2008.
[9] Gilles Brassard, Peter Hoyer, Michele Mosca, and Alain Tapp. Quantum amplitude amplification and estimation. Contemporary Mathematics, 305:53-74, 2002.

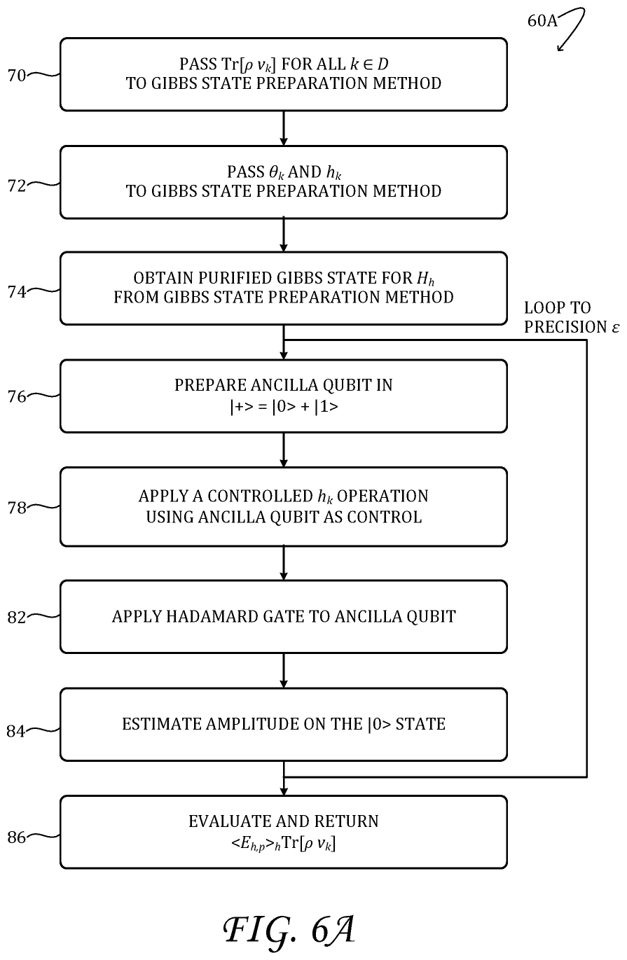

Returning now to the drawings, FIG. 5 illustrates an example method 50 to train a QBM having one or more visible nodes and one or more hidden nodes. The method uses quantum relative entropy as a cost function and includes estimation of the gradient of the quantum relative entropy.

At 52 of method 50, a QBM having visible and hidden nodes is instantiated in a quantum computer. Here each visible and each hidden node of the QBM is associated with a different corresponding qubit of a plurality of qubits of the quantum computer. As described above, the state of each of the plurality of qubits contributes to the global energy of the QBM according to a set of weighting factors.

At 54 initial values of the weighting factors—e.g., biases θᵢ and weights wᵢⱼ—are provided to the QBM. As noted above, the initial values of the weighting factors may be incorporated into a distribution σᵥ over the one or more visible nodes of the QBM, for example.

At 56 a predetermined distribution of training data is provided to the visible nodes of the QBM. Generally speaking, training data may be provided so as to span the entire visible subsystem of the QBM, or any subset thereof. For generative applications, for example, the training distribution may cover all of the visible nodes, whereas for some classification tasks, it may be sufficient to compute a training loss function (such as a classification error rate) on a subset of visible nodes designated as the ‘output units’ or ‘output qubits’. Accordingly, the plurality of qubits of the qubit register may include one or more designated output qubits corresponding to one, some, or all of the visible nodes of the QBM, and a distribution of training data is provided over the one or more output qubits.

As noted above, the distribution of training data may take the form of a density operator ρ, which represents the quantum state of the visible subsystem as a statistical distribution or mixture of pure quantum states. Accordingly, the density operator may represent a statistically-weighted collection of possible observations of a quantum system, analogous to a probability distribution over classical state vectors. In some examples, a density operator ρ may represent superpositions of different basis states and/or entangled states. Superposition states in quantum data may represent uncertainty and/or ambiguity in the data. Entangled states may represent correlations between states. Accordingly, a density operator ρ may be used to more precisely describe systems in which uncertainty and/or non-trivial correlations occur, relative to any competing classical distribution. In some examples, classical distributions of training data may be converted to an appropriate density operator for use in the methods herein.

At 58 the QBM is driven to thermal equilibrium by repeated resetting of the state of each node and application of a logistic measurement function. At 60 the gradient of the quantum relative entropy between the one or more output qubits and the distribution of training data is estimated with respect to the weighting factors, based on the thermally equilibrated qubit state held in the quantum computer. At 62 it is determined whether a minimum of the quantum relative entropy has been reached with respect to the set of weighting factors. If a minimum has not been reached, then the method advances to 64, where the weighting factors are adjusted (i.e., trained) based on the estimated gradient of the quantum relative entropy, using the quantum relative entropy as a cost function. From here the equilibrium state of the QBM is again approached, now using the adjusted weighting factors. If a minimum in the quantum relative entropy is reached at 62, then the training procedure concludes with the currently adjusted values of the weighting factors accepted as trained values. The trained QBM may now be provided, at 66, subsequent non-training distributions, for generative, discriminative, or classification tasks. In other examples, execution of method 50 may loop back to 56 where an additional training distribution is offered and processed.

Whereas computing the gradient of the average log-likelihood is a straightforward task when training a classical Boltzmann machine, finding the gradient of the quantum relative entropy is much harder. The reason is that, in general, [∂_{θ}H(θ), H(θ)]≠0. This means that certain rules for finding the derivative no longer hold. One important example, used repeatedly herein, is Duhamel's formula:

∂_{θ}e^{H(θ)}=∫₀¹dse^{H(θ)s}∂θ_{H}(θ)e^{H(θ)(1-s)}. (12)

This formula is proven by expanding the operator exponential in a Trotter-Suzuki expansion with r time-slices, differentiating the result and then taking the limit as r→∞. However, the relative complexity of this expression compared to what would be expected from the product rule serves as an important reminder that computing the gradient is not a trivial exercise. A similar formula for the logarithm is provided in the Appendix herein.

Because this disclosure involves functions of matrices, the notion of monotonicity is relevant, in addition to a formal definition of a QBM. For some approximations to hold, it is also necessary to define the notion of concavity, in order to use Jensen's inequality.

### Definition 1. Operator Monoticity

A function ƒ is operator monotone with respect to the semidefinite order if 0 [symbol] A [symbol] B, for two symmetric positive definite operators, implies ƒ(A) [symbol] ƒ(B). A function is operator concave w.r.t. the semidefinite order if cƒ(A)+(1−c)ƒ(B) [symbol] ƒ(cA+(1−c)B) for all positive definite A, B, and c∈[0, 1].

### Definition 2

A quantum Boltzmann machine (QBM) is defined as a quantum mechanical system that acts on a tensor product of Hilbert spaces [symbol] ᵥ [symbol] ₕ∈ [symbol] ²^{ⁿ} that correspond to the visible and hidden subsystems of the QBM. The QBM has a Hamiltonian of the form H∈ [symbol] ²^{ⁿ}^{×2}^{ⁿ} such that ∥H−diag(H)∥>0. The QBM takes these parameters and then outputs a state of the form Trₕ

$$( \frac{{e}^{- H}}{Tr ( {e}^{- H} )} ) ,$$

where Trₕ(⋅) refers to the partial trace over the hidden subspace of the model.

As described above, the quantum relative entropy cost function for a QBM with hidden units is given by

[symbol]

_{ρ}(H)=S(ρ|Trₕ[e^{-H}/Tr[e^{-H}]]), (13)

where S(ρ|σ):=Tr [ρ log ρ]−Tr [ρ log σ] is the quantum relative entropy. In the following, the reduced density matrix on the visible units of the QBM is denoted σ=Trₕ [e^{-H}/Tr [e^{-H}]]. A regularization term may be included in the expression above to penalize unnecessary quantum correlations in the model. For simplicity, however, such regularization has been omitted herein.

In the case of an all-visible QBM (which corresponds to dim( [symbol] ₕ)=1) a closed form expression for the gradient of the quantum relative entropy is known:

$$\frac{\partial {𝒪}_{ρ} ( H )}{\partial θ} = - Tr [ \frac{\partial }{\partial θ} ρ log σ ] , \qquad ( 14 )$$

which can be simplified using log(exp(−H))=−H and Duhamels formula to obtain the following equation for the gradient. Denoting ∂_{θ}:=∂/∂θ,

Tr[ρ∂_{θ}H]−Tr[e^{-H}∂_{θ}H]/Tr[e^{-H}]. (15)

However, the above gradient formula is not generally valid, and indeed does not hold, if hidden units are included. Allowing for hidden units, it is necessary to addition-ally trace out the hidden subsystem, which results in the majorised distribution σᵥ:=Trₕ [e^{-H}/Tr [e^{-H}]]. In general, the adapted cost function for the QBM with hidden units takes the form

[symbol]

_{ρ}(H)=S(ρ∥Trₕ[e^{-H}]/Tr[^{-H}]. (16)

Note that H depends on variables that will be altered during the training process, while ρ is the target density matrix on which the training will have no influence. Therefore, in estimating the gradient of the above, it is possible to omit the Tr [ρ log ρ] and obtain:

$$\frac{\partial {𝒪}_{ρ} ( H )}{\partial θ} = - Tr [ \frac{\partial }{\partial θ} ρ log {σ}_{v} ] , \qquad ( 17 )$$

where with σᵥ:=Trₕ [e^{-H}]/Tr [e^{-H}] is denoted the reduced density matrix, which is marginalised over the hidden units.

Two different training variants will now be discussed. While the first is less general, it gives an easily implementable algorithm and strong bounds using based on optimizing a variational bound. The second approach is, on the other hand, applicable to any problem instance and represents a general-purpose gradient-optimisation algorithm for relative-entropy training. The no-free-lunch theorem suggests that no (good) bounds can be obtained without assumptions on the problem instance, and indeed, the general algorithm exhibits, potentially, exponentially worse complexity. However, it may still be possible to make use of the second variant for specific applications, particularly because it gives a generally applicable algorithm for training QBMs on a quantum device. This appears to be the first known result of this kind.

### Approach 1: Variational Training for Restricted Hamiltonians

The first approach is based on a variational bound of the objective function, i.e., the quantum relative entropy. In order to operationalize this approach, certain assumptions on the Hamiltonian are relied upon. These assumptions are important, as several instances of scalar calculus fail on transitioning to matrix functional analysis, and, for gradient-based approaches in particular, the assumptions are required in order to obtain a feasible analytical solution.

The Hamiltonian for a QBM may be expressed as

H=Hᵥ+Hₕ+Hᵢₙₜ, (18)

which represents the energy operator acting on the visible units, the hidden units and a third interaction operator that creates correlations between the two. It is further assumed, for simplicity, that there are two sets of operators {vₖ} and {hₖ} composed of D=Wᵥ+Wₕ+Wᵢₙₜ terms with

$${H}_{v} = {\sum }_{k = 1}^{{W}_{v}} {θ}_{k} {v}_{k} ⊗ I , \\ {H}_{h} = {\sum }_{k = {W}_{v} + 1}^{{W}_{v} + {W}_{h}} {θ}_{k} I ⊗ {h}_{k} \\ {H}_{int} = {\sum }_{k = {W}_{v} + {W}_{h} + 1}^{{W}_{v} + {W}_{h} + {W}_{int}} {θ}_{k} {v}_{k} ⊗ {h}_{k} , \\ [ {h}_{k} , {h}_{j} ] = 0 ∀ j , k . \qquad ( 19 )$$

While this implies that the Hamiltonian can in general be expressed as

$$H = {\sum }_{k = 1}^{D} {θ}_{k} {v}_{k} ⊗ {h}_{k} , \qquad ( 20 )$$

it is useful to break up the Hamiltonian into the above form, to emphasize the qualitative difference between the types of terms that can appear in this model.

The intention of the form of the Hamiltonian in Eq. 19 is to force the non-commuting terms to act only on the visible units of the model. In contrast, only commuting Hamiltonian terms act on the hidden register. Since the hidden units commute, the eigenvalues and eigenvectors for the Hamiltonian can be expressed as text use

H|vₕ [symbol] ⊗|h [symbol] =λᵥ_{ₕ}_{,h}|vₕ [symbol] ⊗|h [symbol] , (21)

where both the conditional eigenvectors and eigenvalues for the visible subsystem are functions of the eigenvector |h [symbol] obtained in the hidden register. This allows the hidden units to select between eigenbases to interpret the input data while also penalizing portions of the accessible Hilbert space that are not supported by the training data. However, since the hidden units commute, they cannot be used to construct a non-diagonal eigenbasis. This division of labor between the visible and hidden layers not only helps build intuition about the model but also opens up the possibility for more efficient training algorithms to exploit this fact.

For the following result, a variational bound is used in order to train the QBM weights for a Hamiltonian H of the form given in Eq. 20. The variational bound is expressible compactly in terms of a thermal expectation against a fictitious thermal probability distribution, as defined below.

### Definition 3

Let \tilde{H}ₕ=ΣₖθₖTr [ρvₖ] hₖ be the Hamiltonian acting conditioned on the visible subspace only on the hidden subsystem of the Hamiltonian H:=Σₖθₖvₖ⊗hₖ. Then the expectation value over the marginal distribution over the hidden variables h is defined as:

$${𝔼}_{h} ( \cdot ) = {\sum }_{h} \frac{( \cdot ) {r}^{- Tr [ ρ {\tilde{H}}_{h} ]}}{{Σ}_{h} {e}^{- Tr [ ρ {\tilde{H}}_{h} ]}} . \qquad ( 22 )$$

This definition is now used to state the expression for the gradient of the variational bound on the quantum relative entropy.

### Definition 4

Assume that the Hamiltonian of the QBM takes the form H, where θₖ are the parameters that determine the interaction strength and vₖ, hₖ are unitary operators. Furthermore, let hₖ|h [symbol] =E_{h,k}|h [symbol] be the eigenvalues of the hidden subsystem, and let [symbol] ₕ(⋅) be as given by Def. 3, i.e., the expectation value over the effective Boltzmann distribution of the visible layer with \tilde{H}ₕ:=Σ_{h,k}θₖvₖ. Finally, let the variational upper bound of the objective function be given by

$$\begin{matrix}\tilde{S} ( ρ \vert H ) \text{:=} Tr [ ρ log ρ ] + Tr [ ρ {\sum }_{k} {𝔼}_{h} [ {E}_{h , k} {θ}_{k} {v}_{k} ] + {𝔼}_{h} [ log {α}_{h} ] ] - log Z , \\ where & ( 23 ) \\ {α}_{h} = \frac{{e}^{- Tr [ ρ {\tilde{H}}_{h} ]}}{{Σ}_{h} {e}^{- Tr [ ρ {\tilde{H}}_{h} ]}} . & ( 24 )\end{matrix}$$

This is the corresponding Gibbs distribution for the visible units.

Lemma 1.

Under the assumptions of Def. 4, \tilde{S} is a variational upper bound on the quantum relative entropy, meaning that \tilde{S}(ρ|H)≥S(ρ|e^{-H}/Z). Furthermore, the derivatives of this upper bound with respect to the parameters of the Boltzmann machine are

$$\frac{\partial \tilde{S} ( ρ \vert H )}{{\partial }_{{θ}_{p}}} = {𝔼}_{h} [ Tr ( ρ {E}_{h , p} {v}_{p} ] ] - Tr [ \frac{\partial H}{\partial {θ}_{p}} \frac{{e}^{- H}}{Z} ] . \qquad ( 25 )$$

Proof.

First derived is the gradient of the normalization term (Z) in the relative entropy, which can be trivially evaluated using Duhamels formula to obtain

$$\frac{\partial }{\partial {θ}_{p}} log Tr [ {e}^{- H} ] = - Tr [ \frac{\partial H}{\partial {θ}_{p}} \frac{{e}^{- H}}{Z} ] = - Tr [ σ {\partial }_{{θ}_{p}} H ] . \qquad ( 26 )$$

Note that this term is evaluated by first preparing the Gibbs state σ_{Gibbs}:=e^{-H}/Z and then evaluating the expectation value of the operator ∂_{θ}_{ⱼ}H w.r.t. the Gibbs state, using amplitude estimation for the Hadamard test. If T_{Gibbs} is the query complexity for the Gibbs state preparation, then the query complexity of the whole algorithm including the phase estimation step is then given by O(T_{Gibbs}/\tilde{∈}) for an \tilde{∈}-accurate estimate of phase estimation.

Proceeding now with the gradient evaluations for the model, the reader will recall that the Hamiltonian H is assumed to take the form

$$H \text{:=} {\sum }_{k} {θ}_{k} {v}_{k} ⊗ {h}_{k} , \qquad ( 27 )$$

where vₖ and hₖ are operators acting on the visible and hidden units respectively, and that hₖ=dₖ is assumed to be diagonal in the chosen basis. Under the assumption that [hᵢ, hⱼ]=0, ∇i, j, c.f., the assumptions in Eq. 19, there exists a basis {|h [symbol] } for the hidden subspace such that hₖ|h [symbol] =E_{h,k}|h [symbol] . With these assumptions, the logarithm may be reformulated as

$$\begin{matrix}log {Tr}_{h} [ {e}^{- H} ] = log ( {\sum }_{v , {v}^{′} , h} 〈 v , h \vert {e}^{- {Σ}_{k} {θ}_{k} {v}_{k} ⊗ {h}_{k}} \vert {v}^{′} , h 〉 \vert v 〉 〈 {v}^{′} \vert ) & ( 28 ) \\ = log ( {\sum }_{v , {v}^{′} , h} 〈 v \vert {e}^{- {Σ}_{k} {E}_{h , k} {θ}_{k} {v}_{k}} \vert {v}^{′} 〉 \vert v 〉 〈 {v}^{′} \vert ) & ( 29 ) \\ = log ( {\sum }_{h} {e}^{- {Σ}_{k} {E}_{h , k} {θ}_{k} {v}_{k}} ) , & ( 30 )\end{matrix}$$

where it is important to note that vₖ are operators, and hence, the matrix representation of these are used in the last step. In order to further simplify this expression, it is noted that each term in the sum is a positive semi-definite operator. In particular, it will be noted that the matrix logarithm is operator concave and operator monotone, and hence by Jensen's inequality, for any sequence of non-negative number {αᵢ}:Σᵢαᵢ=1,

$$log ( \frac{{\sum }_{i = 1}^{N} {α}_{i} {U}_{i}}{{Σ}_{j} {α}_{j}} ) \geq \frac{{\sum }_{i = 1}^{N} {α}_{i} log ( {U}_{i} )}{{Σ}_{j} {α}_{j}} . \qquad ( 31 )$$

Further, since Tr [ρ log ρ]−Tr [ρ log σᵥ] is being optimized, for arbitrary choice of {αᵢ}ᵢ under the above constraints,

$$Tr [ ρ log ( {\sum }_{h = 1}^{N} {e}^{- {Σ}_{k} {E}_{h , k} {θ}_{k} {v}_{k}} ) ] = Tr [ ρ log ( {\sum }_{h = 1}^{N} {α}_{h} \frac{{e}^{- {Σ}_{k} {E}_{h , k} {θ}_{k} {v}_{k}} \text{/} {α}_{h}}{{Σ}_{{h}^{′}} {α}_{{h}^{′}}} ) ] \geq - Tr [ ρ \frac{{Σ}_{h} {α}_{h} {Σ}_{k} {E}_{h , k} {θ}_{k} {v}_{k} + {Σ}_{h} {α}_{h} log {α}_{h}}{{Σ}_{{h}^{′}} {α}_{{h}^{′}}} ] . \qquad ( 32 )$$

Hence, the variational bound on the objective function for any {αᵢ}ᵢ is

$${𝒪}_{ρ} ( H ) = Tr [ ρ log ρ ] - Tr [ ρ log {σ}_{v} ] \leq Tr [ ρ log ρ ] + Tr [ ρ \frac{{Σ}_{h} {α}_{h} {Σ}_{k} {E}_{h , k} {θ}_{k} {v}_{k} + {Σ}_{h} {α}_{h} log {α}_{h}}{{Σ}_{{h}^{′}} {α}_{{h}^{′}}} ] + log Z \text{=:} \tilde{S} , \qquad ( 33 )$$

which yields

$$\begin{matrix}\frac{\partial \tilde{S}}{{\partial }_{{θ}_{p}}} = - Tr [ \frac{\partial H}{\partial {θ}_{p}} \frac{{e}^{- H}}{Z} ] + Tr [ \frac{\partial }{\partial {θ}_{p}} ρ {\sum }_{h} {α}_{h} {\sum }_{k} {E}_{h , k} {θ}_{k} {v}_{k} ] + \frac{\partial }{\partial {θ}_{p}} {\sum }_{h} {α}_{h} log {α}_{h} & ( 34 ) \\ = - Tr [ \frac{\partial H}{\partial {θ}_{p}} \frac{{e}^{- H}}{Z} ] + \frac{\partial }{\partial {θ}_{p}} ( {\sum }_{h} {α}_{h} Tr [ ρ {\sum }_{k} {E}_{h , k} {θ}_{k} {v}_{k} ] + {\sum }_{h} {α}_{h} log {α}_{h} ) & ( 35 )\end{matrix}$$

where the first term results from the partition sum. The former term can be seen as a new effective Hamiltonian, while the latter term is the entropy. The latter term hence resembles the free energy F(h)=E(h)−TS(h), where E(h) is the mean energy of the effective system with energies E(h):=Tr [ρΣₖE_{h,k}θₖvₖ], T the temperature and S(h) the Shannon entropy of the αₕ distribution. Now αₕ terms are chosen to minimize this variational upper bound.

It is well-established in statistical physics, see for example [1], that the distribution that maximizes the free energy is the Boltzmann (or Gibbs) distribution, i.e.,

$${α}_{h} = \frac{{e}^{- Tr [ ρ {\tilde{H}}_{h} ]}}{{Σ}_{h} {e}^{- Tr [ ρ {\tilde{H}}_{h} ]}} , \qquad ( 36 )$$

where \tilde{H}ₕ:=ΣₖE_{h,k}θₖvₖ is a new effective Hamiltonian on the visible units, and the {αᵢ} are given by the corresponding Gibbs distribution for the visible units.

Therefore, the gradients can be taken with respect to this distribution and the bound above, where Tr [ρ\tilde{H}ₕ] is the mean energy of the effective visible system w.r.t. the data-distribution. For the derivative of the energy term,

$$\begin{matrix} \frac{\partial }{\partial {θ}_{p}} {\sum }_{h} {α}_{h} Tr [ ρ {\sum }_{k} {E}_{h , k} {θ}_{k} {v}_{k} ] = & ( 37 ) \\ = {\sum }_{h} ( {α}_{h} ( {𝔼}_{{h}^{′}} [ Tr [ ρ {E}_{{h}^{′} , p} {v}_{p} ] ] - Tr [ ρ {E}_{h , p} {v}_{p} ] ) Tr [ ρ {\tilde{H}}_{h} ] + {α}_{h} Tr [ ρ {E}_{h , p} {v}_{p} ] ) & ( 38 ) \\ = {𝔼}_{h} [ ( {𝔼}_{{h}^{′}} [ Tr [ ρ {E}_{{h}^{′} , p} {v}_{p} ] ] - Tr [ ρ {E}_{h , p} {v}_{p} ] ) Tr [ ρ {\tilde{H}}_{h} ] + Tr [ ρ {E}_{h , p} {v}_{p} ] ] , & ( 39 )\end{matrix}$$

while the entropy term yields

$$\frac{\partial }{\partial {θ}_{p}} {\sum }_{h} {α}_{h} log {α}_{h} = {\sum }_{h} {α}_{h} ( [ Tr [ ρ {E}_{h , p} {v}_{p} ] - {𝔼}_{{h}^{′}} [ Tr [ ρ {E}_{{h}^{′} , p} {v}_{p} ] ] ] Tr [ ρ {\tilde{H}}_{h} ] - Tr [ ρ {E}_{h , p} {v}_{p} ] ) + {\sum }_{h} {α}_{h} ( Tr [ ρ {E}_{h , p} ] - {𝔼}_{{h}^{′}} [ Tr [ ρ {E}_{{h}^{′} , p} {v}_{p} ] ] ) log Tr [ {e}^{- {\tilde{H}}_{h}} ] + {𝔼}_{{h}^{′}} [ Tr [ ρ {E}_{{h}^{′} , p} {v}_{p} ] ] . \qquad ( 40 )$$

This can be further simplified to

$$\begin{matrix}{\sum }_{h} {α}_{h} ( Tr [ ρ {E}_{h , p} {v}_{p} ] - {𝔼}_{{h}^{′}} [ Tr [ ρ {E}_{{h}^{′} , p} {v}_{p} ] ] ) Tr [ ρ {\tilde{H}}_{h} ] & ( 41 ) \\ = {𝔼}_{h} [ ( Tr [ ρ {E}_{{h}^{′} , p} {v}_{p} ] - {𝔼}_{{h}^{′}} [ Tr [ ρ {E}_{{h}^{′} , p} {v}_{p} ] ] ) Tr [ ρ {\tilde{H}}_{h} ] ] . & ( 42 )\end{matrix}$$

The resulting gradient for the variational bound for the visible terms is hence given by

$$\frac{\partial \tilde{S}}{{\partial }_{{θ}_{p}}} = {𝔼}_{h} [ Tr [ ρ {E}_{h , p} {v}_{p} ] ] - Tr [ \frac{\partial H}{\partial {θ}_{p}} \frac{{e}^{- H}}{Z} ] . \qquad ( 43 )$$

Notably, if one considers no interactions between the visible and hidden units, then indeed the gradient above reduces to the case of the visible Boltzmann machine, which was treated in [2], resulting in the gradient

$$Tr [ ρ {\partial }_{{θ}_{p}} H ] - Tr [ \frac{{e}^{- H}}{Z} {\partial }_{{θ}_{p}} H ] , \qquad ( 44 )$$

under applicable assumptions on the form of H, ∂_{θ}_{ₚ}H=vₚ.

Operationalizing the Gradient-Based Training.

From Lemma 1, it is known that the derivative of the relative entropy w.r.t. any parameter θₚ can be stated as

$$\frac{\partial \tilde{S}}{{\partial }_{{θ}_{p}}} = {𝔼}_{h} [ {E}_{h , p} ] Tr [ ρ {v}_{p} ] - Tr [ \frac{\partial H}{\partial {θ}_{p}} \frac{{e}^{- H}}{Z} ] . \qquad ( 45 )$$

Since evaluating the latter part is, as mentioned above, straightforward, an algorithm is now given for evaluating the first part.

In view of the foregoing analysis, it is possible to evaluate each term Tr [ρvₖ] individually for all k∈[D], i.e., all D dimensions of the gradient via the Hadamard test for vₖ, assuming vₖ is unitary. More generally, for non-unitary vₖ one could evaluate this term using a linear combination of unitary operations. Therefore, the remaining task is to evaluate the terms [symbol] ₕ[E_{h,p}] in Eq. 45, which reduces to sampling according to the distribution {αₕ}. For this it is necessary to be able to create a Gibbs distribution for the effective Hamiltonian \tilde{H}ₕ=ΣₖθₖTr [ρvₖ] hₖ that contains only D terms and can hence be evaluated efficiently as long as D is small, which can generally be assumed. In order to sample according to the distribution {αₕ}, the factors θₖTr [ρvₖ] in the sum over k are first evaluated via the Hadamard test, and then used in order to implement the Gibbs distribution exp (−\tilde{H}ₕ)/\tilde{Z} for the Hamiltonian

$${\tilde{H}}_{h} = {\sum }_{k} {θ}_{k} Tr [ ρ {v}_{k} ] {h}_{k} . \qquad ( 46 )$$

To this end, the results of [3] are adapted in order to prepare the corresponding Gibbs state, although alternative methods may also be used, e.g., [4].

Theorem 1.

Gibbs state preparation [3]. Suppose that I [symbol] H and we are given K∈ [symbol] ₊ such that ∥H∥≤2K, and let H∈ [symbol] ^{N×N} be a d-sparse Hamiltonian, and we know a lower bound z≤Z=Tr [e^{-H}]. If ϵ∈(0, ⅓), then we can prepare a purified Gibbs state |γ [symbol] _{AB} such that

$$‖ {Tr}_{B} [ \vert γ 〉 {〈 γ \vert}_{AB} ] - \frac{{e}^{- H}}{Z} ‖ \leq ϵ \qquad ( 47 )$$

using

$$\tilde{𝒪} ( \sqrt{\frac{N}{z}} Kd log ( \frac{K}{ϵ} ) log ( \frac{1}{ϵ} ) ) \qquad ( 48 )$$

queries, and

$$\tilde{𝒪} ( \sqrt{\frac{N}{z}} Kd log ( \frac{K}{ϵ} ) log ( \frac{1}{ϵ} ) [ log ( N ) + {log}^{5 \text{/} 2} ( \frac{K}{ϵ} ) ] ) \qquad ( 49 )$$

gates.

Note that by using the above algorithm with \tilde{H}/2, the preparation of the purified Gibbs state will result in the state

$${{{\vert ψ 〉}_{Gibbs} \text{:=} {\sum }_{h} \frac{{e}^{- {E}_{h} \text{/} 2}}{\sqrt{Z}} \vert h 〉}_{A} \vert {φ}_{h} 〉}_{B} , \qquad ( 50 )$$

where |ϕⱼ [symbol] _{B} are mutually orthogonal trash states, which can typically be chosen to be |h [symbol] , i.e., a copy of the first register, which is irrelevant for our computation, and |h [symbol] _{A} are the eigenstates of \tilde{H}. Tracing out the second register will hence result in the corresponding Gibbs state

$${σ}_{h} \text{:=} {\sum }_{h} \frac{{e}^{- {E}_{h}}}{Z} \vert h 〉 {〈 h \vert}_{A} , \qquad ( 51 )$$

and hence the Hadamard test may now be used with input hₖ and σₕ, i.e., the operators on the hidden units and the Gibbs state, and estimate the expectation value [symbol] ₕ [E_{h,k}]. Such a method is provided below.

Theorem 2.

Under the assumptions of Lemma 1 and Theorem 1, [symbol] ∈ [symbol] ^{D} can be computed for such that for any ϵ∈(0, max{⅓, 4 max_{h,p}|E_{h,p}|}) such that

$$\begin{matrix}{‖ 𝒮 - ∇ \tilde{𝒮} ‖}_{max} \leq ϵ , \\ with & ( 52 ) \\ \tilde{𝒪} ( \sqrt{ξ} \frac{D {‖ θ ‖}_{1} {dn}^{2}}{ϵ} ) , & ( 53 )\end{matrix}$$

queries to the oracle O_{H} and O_{ρ} with probability at least ⅔, where ξ:=max[N/z, Nₕ/zₕ], N=2ⁿ, Nₕ=2ⁿ^{ₕ}, and z, zₕ are known lower bounds on the partition functions for the Gibbs state of H and \tilde{H}ₕ respectively.

Proof.

Conceptually, the following steps are performed, starting with Gibbs state preparation followed by a Hadamard test coupled with amplitude estimation to obtain estimates of the probability of a 0 measurement. The proof follows straight from the following algorithm.
1. One starts by preparing a Hadamard test state, i.e., let

$${\vert ψ 〉}_{G i b b s} : = {Σ}_{h} \frac{{e}^{- {E}_{h} / 2}}{\sqrt{Z}} {\vert h 〉}_{A} {\vert {φ}_{h} 〉}_{B} ,$$

be the purified Gibbs state. Then an ancilla qubit is prepared in the |+ [symbol] -state, and a controlled-hₖ conditioned on the ancilla register is applied, followed by a Hadamard gate, i.e.,

½(|0 [symbol] (|ψ [symbol] _{Gibbs}+(hₖ⊗I)|ψ [symbol] _{Gibbs})+|1 [symbol] (|ψ [symbol] _{Gibbs}−(hₖ⊗I)|ψ [symbol] _{Gibbs})) (54)
2. Next an amplitude estimation is performed on the |0 [symbol] state. Let reflector Z:=−2|0 [symbol] [symbol] 0|+I, where I is the identity which is just the Pauli Z matrix up to a global phase, and let G:=(2|ϕ [symbol] [symbol] ϕ|−I) (Z⊗I), for |ϕ [symbol] being the state after the Hadamard test, prior to the measurement. The operator G has then the eigenvalue μ_{±}=±e^{±i2θ} where 2θ=arcsin Pr(0), and Pr(0) is the probability to measure the ancilla qubit in the |0 [symbol] state. Let now T_{Gibbs} be the query complexity for preparing the purified Gibbs state, given in Eq. 48. It is now possible to perform phase estimation with precision e for the operator G requiring O(T_{Gibbs}/\tilde{ϵ}) queries to the oracle of H.
3. Note that the above will return an \tilde{ϵ}-estimate of the probability of the Hadamard test to return 0, if we measure now the phase estimation register. For the outcome, note that

$$\begin{matrix}Pr ( 0 ) = \frac{1}{2} ( 1 + Re 〈 ψ {\vert}_{G i b b s} ( {h}_{k} ⊗ I ) {\vert ψ 〉}_{G i b b s} ) \\ = \frac{1}{2} ( 1 + {\sum }_{h} \frac{{e}^{- {E}_{h}} {E}_{h , k}}{Z} ) \\ = \frac{1}{2} ( 1 + {𝔼}_{h} [ {E}_{h , k} ] ) ,\end{matrix} \qquad ( 55 )$$

from which one can easily infer the estimate of [symbol] ₕ [E_{h,k}] up to precision e for all the k terms.

[symbol]

From the above it is seen that the runtime constitutes the query complexity of preparing the Gibbs state

$${T}_{G i b b s}^{V} = \tilde{𝒪} ( \sqrt{\frac{{2}^{n}}{Z}} \frac{‖ H ( θ ) ‖ d}{ϵ} log ( \frac{‖ H ( θ ) ‖}{\tilde{ϵ}} ) log ( \frac{1}{\tilde{ϵ}} ) ) , \qquad ( 56 )$$

where 2ⁿ is the dimension of the Hamiltonian, as given in Theorem 2 and combining it with the query complexity of the amplitude estimation procedure, i.e., 1/ϵ. However, in order to obtain a final error of ϵ, the error in the Gibbs state preparation must also be accounted for. For this, note that terms of the form Tr_{AB} [ [symbol] ψ|_{Gibbs} (hₖ⊗I)|ψ [symbol] _{Gibbs}^{V}]=Tr_{AB} [(hₖ⊗I)|ψ [symbol] _{Gibbs}^{V} [symbol] ψ|_{Gibbs}^{V}] may be estimated. The error w.r.t. the true Gibbs state σ_{Gibbs} is therefore be estimated as

$${Tr}_{AB} [ ( {h}_{k} ⊗ I ) {\vert ψ 〉}_{Gibbs}^{V} {〈 ψ \vert}_{Gibbs}^{V} ] - {Tr}_{A} [ {h}_{k} {σ}_{Gibbs} ] = {Tr}_{A} [ {h}_{k} {Tr}_{B } [ {\vert ψ 〉}_{Gibbs}^{V} {〈 ψ \vert}_{Gibbs}^{V} ] - {h}_{k} {σ}_{Gibbs} ] \leq {\sum }_{i} {σ}_{i} ( {h}_{k} ) ‖ {Tr}_{B} [ {\vert ψ 〉}_{Gibbs}^{V} {〈 ψ \vert}_{Gibbs}^{V} ] - {σ}_{Gibbs} ‖ \leq \tilde{ϵ} {\sum }_{i} {σ}_{i} ( {h}_{k} ) . \qquad ( 57 )$$

For the final error being less then ϵ, the precision used in the phase estimation procedure, it is necessary to set \acute{ϵ}=ϵ/(2Σᵢσᵢ(hₖ))≤2⁻ⁿ⁻¹ϵ, reminding that hₖ is unitary, and similarly precision ϵ/2 for the amplitude estimation, which yields the query complexity of

$$𝒪 ( \sqrt{\frac{{N}_{h}}{{z}_{h}}} \frac{‖ H ( θ ) ‖ d}{ϵ} ( {n}^{2} + n log ( \frac{‖ H ( θ ) ‖}{ϵ} ) + n log ( \frac{1}{ϵ} ) + log ( \frac{‖ H ( θ ) ‖}{ϵ} ) log ( \frac{1}{ϵ} ) ) ) , \\ ∈ \tilde{O} ( \sqrt{\frac{{N}_{h}}{{z}_{h}}} ( \frac{{n}^{2} {‖ H ( θ ) ‖}_{1} d}{ϵ} ) ) . \qquad ( 58 )$$

where one denotes with A the hidden subsystem with dimensionality 2ⁿ^{ₕ}≤2^{N}, on which the Gibbs state is prepared, and with B, the subsystem for the trash state.

Similarly, the evaluation of the second part in Eq. 45 requires the Gibbs state preparation for H, the Hadamard test, and phase estimation. Similar to the above it is necessary to take the error into account. Letting the purified version of the Gibbs state for H be given by |ψ [symbol] _{Gibbs}, which is obtained using Theorem 1, and letting σ_{Gibbs} be the perfect state, then the error is given by

$${Tr}_{AB} [ ( {v}_{k} ⊗ {h}_{k} ⊗ I ) {\vert ψ 〉}_{Gibbs} {〈 ψ \vert}_{Gibbs} ] - {Tr}_{A} [ ( {v}_{k} ⊗ {h}_{k} ) {σ}_{Gibbs} ] = {Tr}_{A} [ ( {v}_{k} ⊗ {h}_{k} ) {Tr}_{B} [ {\vert ψ 〉}_{Gibbs}^{V} {〈 ψ \vert}_{gibbs}^{V} ] - ( {v}_{k} ⊗ {h}_{k} ) {σ}_{Gibbs} ] \leq {\sum }_{i} {σ}_{i} ( {v}_{k} ⊗ {h}_{k} ) ‖ {Tr}_{B} [ {\vert ψ 〉}_{Gibbs}^{V} {〈 ψ \vert}_{Gibbs}^{V} ] - {h}_{k} {σ}_{Gibbs} ‖ \leq \tilde{ϵ} {\sum }_{i} {σ}_{i} ( {v}_{k} ⊗ {h}_{k} ) , \qquad ( 59 )$$

where in this case A is the subsystem of the visible and hidden subspace and B the trash system. The upper bound on the error is set as above and introducing ξ:=max[N/z, Nₕ/zₕ], one can find that a uniform bound on the query complexity for evaluating

$$\tilde{O} ( \sqrt{ζ} ( \frac{{n}^{2} {‖ H ( θ ) ‖}_{1} d}{ϵ} ) ) , \qquad ( 60 )$$

thus one attains the claimed query complexity by repeating the above procedure for each of the D components of the estimated gradient vector S.

Note that it is also necessary to evaluate the terms Tr [ρvₖ] to precision \hat{ϵ}≤ϵ, which though only incurs an additive cost of D/ϵ to the total query complexity, since this step is required to be performed once. Note that | [symbol] ₕ(hₚ)|≤1 because hₚ is assumed to be unitary. To complete the proof it is necessary only to take the success probability of the amplitude estimation process into account. For completeness, the algorithm is stated in the Appendix and herein only Theorem 5 is referred to, from which it follows that the procedure succeeds with probability at least 8/π². In order to have a failure probability of the final algorithm of less than ⅓, it is necessary to repeat the procedure for all d dimensions of the gradient and to take the median. The number of repetitions may now be bounded in the following way.

Let n_{ƒ} be the number of instances of the gradient estimate such that the error is larger than ϵ, and let nₛ be the number of instances with an error ≤ϵ for one dimension of the gradient, and let the result taken be the median of the estimates, where n=nₛ+n_{ƒ} samples are collected. The algorithm gives a wrong answer for each dimension if

$${n}_{s} \leq ⌊ \frac{n}{2} ⌋ ,$$

since then the median is a sample such that the error is not bound by ϵ. Let p=8/π² be the success probability to draw a positive sample, as is the case of the amplitude estimation procedure. Since each instance of the phase estimation algorithm will independently return an estimate, the total failure probability is given by the union bound, i.e.,

$$P {r}_{f a i l} \leq D \cdot Pr [ {n}_{s} \leq ⌊ \frac{n}{2} ⌋ ] \leq D \cdot {q}^{- \frac{n}{2 p} {( p - \frac{1}{2} )}^{2}} \leq \frac{1}{3} , \qquad ( 61 )$$

which follows from the Chernoff inequality for a binomial variable with p>½, which is given in the present case. Therefore, by taking

$$n \geq \frac{2 p}{{( p - 1 / 2 )}^{2}} log ( 3 D ) = \frac{16}{{( 8 - {π}^{2} / 2 )}^{2}} log ( 3 D ) = O ( log ( 3 D ) ) ,$$

a total failure probability of at most ⅓ is achieved. This is sufficient to demonstrate the validity of the algorithm if

Tr[ρ\tilde{H}ₕ] (62)

is known exactly. This is difficult to do because the probability distribution αₕ is not usually known apriori. As a result, it is assumed that the distribution will be learned empirically and to do so it is necessary to draw samples from the purified Gibbs states used as input. This sampling procedure will incur errors. To take such errors into account, assume that it is possible to obtain estimates Tₕ of Eq. 62 with precision δₜ, i.e.,

|Tₕ−Tr[ρ\tilde{H}ₕ]≤δₜ. (63)

Under this assumption, it is now possible to bound the distance |αh−\tilde{α}ₕ| in the following way. Observe that

$$\vert {α}_{h} - {\tilde{α}}_{h} \vert = \vert \frac{{e}^{- T r [ ρ {\tilde{H}}_{h} ]}}{{Σ}_{h} {e}^{- Tr [ ρ {\tilde{H}}_{h} ]}} - \frac{{T}_{h}}{{Σ}_{h} {T}_{h}} \vert \leq \vert \frac{{e}^{- T r [ ρ {\tilde{H}}_{h} ]}}{{Σ}_{h} {e}^{- T r [ ρ {\tilde{H}}_{h} ]}} - \frac{{T}_{h}}{{Σ}_{h} {e}^{- T r [ ρ {\tilde{H}}_{h} ]}} \vert + \vert \frac{{T}_{h}}{{Σ}_{h} {e}^{- T r [ ρ {\tilde{H}}_{h} ]}} - \frac{{T}_{h}}{{Σ}_{h} {T}_{h}} \vert , \qquad ( 64 )$$

and hence it is necessary to bound the following two quantities in order to bound the error. First, a bound is required on

e^{-Tr[ρ\tilde{H}}^{ₕ}^{]}−e^{-T}^{ₕ}|. (65)

For this, let ƒ(s):=Tₕ(1−s)+Tr [ρ\tilde{H}ₕ] s, such that Eq. 65 can be rewritten as

$$\begin{matrix}\vert {e}^{- f ( 1 )} - {e}^{- f ( 0 )} \vert = \vert {\int }_{0}^{1} \frac{d}{d s} {e}^{- f ( s )} ds \vert \\ = \vert {\int }_{0}^{1} \dot{f} ( s ) {e}^{- f ( s )} ds \vert \\ = \vert {\int }_{0}^{1} ( T r [ ρ {\tilde{H}}_{h} ] - {T}_{h} ) {e}^{- f ( s )} ds \vert \\ \leq δ {e}^{- m i {n}_{s} f ( s )} \\ \leq δ {e}^{- T r [ ρ {H}_{h} ] + δ}\end{matrix} \qquad ( 66 )$$

and assuming δ≤log(2), this reduces to

|e^{-ƒ(1)}−e^{-ƒ(0)}|≤2δe^{-Tr[ρ\tilde{H}}^{ₕ}^{]}. (67)

Second,

$$\vert {\sum }_{h} {e}^{- T r [ ρ {\tilde{H}}_{h} ]} - {\sum }_{h} {T}_{h} \vert \leq 2 δ {\sum }_{h} {e}^{- T r [ ρ {\tilde{H}}_{h} ]} . \qquad ( 68 )$$

Using this, Eq. 64 can be bounded above by

$$\frac{2 δ {e}^{- Tr [ ρ {\tilde{H}}_{h} ]}}{{\sum }_{h} {e}^{- Tr [ ρ {\tilde{H}}_{h} ]}} + \vert {T}_{h} \vert \vert \frac{1}{{\sum }_{h} {e}^{- Tr [ ρ {\tilde{H}}_{h} ]}} - \frac{1}{( 1 - 2 δ ) {\sum }_{h} {e}^{- Tr [ ρ {\tilde{H}}_{h} ]}} \vert \leq \frac{2 δ {e}^{- Tr [ ρ {\tilde{H}}_{n} ]}}{{\sum }_{h} {e}^{- Tr [ ρ {\tilde{H}}_{h} ]}} + \frac{4 δ \vert {T}_{h} \vert}{{\sum }_{h} {e}^{- Tr [ ρ {\tilde{H}}_{h} ]}} , \qquad ( 69 )$$

where δ≤¼ is applied. Note that

4ϵ|Tₕ|≤4δ(e^{-Tr[ρ\tilde{H}}^{ₕ}^{]}+2δe^{-Tr[ρ\tilde{H}}^{ₕ}^{]})=e^{-Tr[ρ\tilde{H}}^{ₕ}^{]}(4δ+8δ²)≤e^{-Tr[ρ\tilde{H}}^{ₕ}^{]}(4δ+2δ)≤6δe^{-Tr[ρ\tilde{H}}^{_{H}}^{]}, (70)

which leads to a final error of

$$\vert {α}_{h} - {\tilde{α}}_{h} \vert \leq 8 δ \frac{{e}^{- T r [ ρ {\tilde{H}}_{h} ]}}{{Σ}_{h} {e}^{- T r [ ρ {\tilde{H}}_{h} ]}} . \qquad ( 71 )$$

With this it is now possible to bound the error in the expectation w.r.t. the faulty distribution for some function ƒ(h) to be

$$\vert {𝔼}_{h} ( f ( h ) ) - {\tilde{𝔼}}_{h} ( f ( h ) ) \vert \leq 8 δ {\sum }_{h} \frac{f ( h ) {e}^{- T r [ ρ {\tilde{H}}_{h} ]}}{{Σ}_{h} {e}^{- T r [ ρ {\tilde{H}}_{h} ]}} \leq 8 {δmax}_{h} f ( h ) . \qquad ( 72 )$$

This can now be used in order to estimate the error introduced in the first term of Eq. 45 through errors in the distribution {αₕ} as

$$\vert {𝔼}_{h} [ {E}_{h p} ] T r [ ρ {v}_{p} ] - \tilde{𝔼} [ {E}_{h p} T r [ ρ {v}_{p} ] ] \vert \leq 8 {δmax}_{h} \vert {E}_{h p} T r [ ρ {v}_{p} ] \vert \leq 8 δ {max}_{h , p} \vert {E}_{h p} \vert , \qquad ( 73 )$$

where in the last step the unitarity of vₖ and the Von-Neumann trace inequality was used. For an final error of ϵ, δₜ=ϵ/[16 max_{h,p}|E_{h,p}] is therefore chosen, to ensure that this sampling error incurrs at most half the error budget of ϵ. Thus it is ensured that δ≤¼ if ϵ≤4 max_{h,p}|E_{h,p}|.

It is possible to improve the query complexity of estimating the above expectation by values by using amplitude amplification, since one obtains the measurement via a Hadamard test. For this case only O(max_{h,p}|E_{h,p}|/ϵ) samples are required in order to achieve the desired accuracy from the sampling. Noting that it may not be possible to even access \tilde{H}ₕ without any error, it is deduced that the error of the individual terms of \tilde{H}ₕ for an ϵ-error in the final estimate must be bounded by δₜv∥θ∥₁, where with abuse of notation, δₜ now denotes the error in the estimates of E_{h,k}. Even taking that into account, the evaluation of this contribution is dominated by the second term, and hence can be neglected in the analysis.

Theorem 2 shows that the computational complexity of estimating the gradient grows the closer one approaches a pure state, since for a pure state the inverse temperature β→∞, and therefore the norm ∥H(θ)∥→∞, as the Hamiltonian is depending on the parameters, and hence the type of state described. In such cases one typically would rely on alternative techniques. However, this cannot be generically improved because otherwise it would be possible to find minimum energy configurations using a number of queries in o(\sqrt{N}), which would violate lower bounds for Grover's search. Therefore more precise statements of the complexity will require further restrictions on the classes of problem Hamiltonians to avoid lower bounds imposed by Grover's search and similar algorithms.

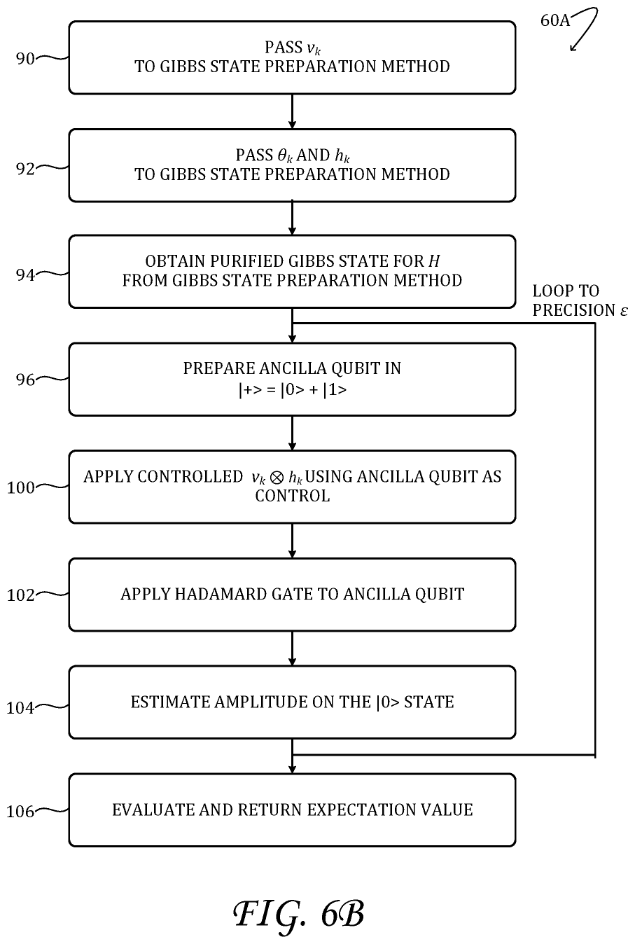

Returning again to the drawings, FIGS. 6A and 6B illustrate an example method 60A to estimate the gradient of the quantum relative entropy of a restricted QBM having visible and hidden nodes. In a restricted QBM, the Hamiltonian terms acting on the hidden units mutually commute by definition herein. As evident from Eq. 45, the estimated gradient may be computed as a difference of two terms, the first term relating to the training distribution and the second term relating to the quantum state of the visible nodes. Accordingly, FIG. 6A illustrates aspects of method 60A related to computation of the first term, while FIG. 6B illustrates aspects of method 60A related to computation of the second term. Method 60A may be employed as a particular instance of step 60 in the training method of FIG. 5. Each step of this method is developed in detail in the description above; accordingly, the present description provides only summary detail to enable the reader to understand the process flow in one non-limiting example.

In method 60A, estimation of the gradient of the quantum relative entropy of a QBM includes computing a variational upper bound on the quantum relative entropy, according to the following algorithm. Beginning in FIG. 6A, at 70 of method 60A, the trace Tr [ρvₖ] computed for all k∈D is passed to a Gibbs-state preparation method (vide supra). At 72, biases θₖ and operator hₖ are also passed to the Gibbs-state preparation method. At 74 the Gibbs-state preparation method is executed, resulting in population of the plurality of qubits of the quantum computer with a purified Gibbs state for Hamiltonians Hₕ. In this method, estimating the gradient includes using substantially commuting operators (i.e., having a commutator which is small or negligible in comparison to each operator) to assign an energy penalty to each qubit corresponding to a hidden node of the QBM.

At 76 of method 60A, a control loop is encountered wherein an ancilla qubit is prepared in the state |+ [symbol] =|0 [symbol] +|1 [symbol] . At 78 a controlled hₖ operation is performed, using the ancilla qubit prepared at 76 as a control. At 82 a Hadamard gate is applied to the ancilla qubit. Then, at 84, the amplitude of the ancilla qubit state is estimated on the 10) state. At this point in the method, the confidence analysis described above is applied in order to determine whether additional measurements are required to achieve precision ϵ. If so, execution returns to 76. Otherwise, the product <E_{h,p}>ₕ Tr [ρvₖ] of the expectation value and the trace is evaluated and returned.

Turning now to FIG. 6B, at 90 of method 60A, the visible state vₖ is passed to the Gibbs-state preparation method. At 92, biases θₖ and operator hₖ are also passed to the Gibbs-state preparation method. At 94 the Gibbs-state preparation method is executed, thereby populating the plurality of qubits of the quantum computer with a purified Gibbs state for Hamiltonian H.

At 96 of method 60A, a control loop is encountered wherein an ancilla qubit is prepared in the state |+ [symbol] =|0 [symbol] +|1 [symbol] . At 100, a controlled vₖ⊗hₖ operation is applied, using the ancilla qubit as a control, prior to application at 102 of a Hadamard gate on the ancilla qubit. Then, at 104, the amplitude of the ancilla qubit state is estimated on the |0 [symbol] state. At this point in the method, the confidence analysis described above is applied in order to determine whether additional measurements are required to achieve precision ϵ. If so, execution returns to 96. Otherwise, the resulting expectation value is evaluated and returned.

### Approach 2: Training with Higher Order Divided Differences and Function Approximations

This section describes a scheme to train a QBM using divided difference estimates for the relative entropy error and to generate differentiation formulas by differentiating and interpolating. First an interpolating polynomial is constructed from the data. Second, an approximation of the derivative at any point can be obtained by a direct differentiation of the interpolant. In the following it is assumed that it will be possible to simulate and evaluate Tr [ρ log σᵥ]. As this is generally non-trivial, and the error is typically large, in the next section is proposed a different, more specialised approach that, however, still allows training of arbitrary models with the relative entropy objective.

In order to proof the error of the gradient estimation via interpolation, it is necessary to first establish error bounds on the interpolating polynomial which can be obtained via the remainder of the Lagrange interpolation polynomial. The gradient error for the objective can then be obtained by as a combination of this error with a bound on the n+1-st order derivative of the objective. The first step is to bound the error in the polynomial approximation.

Lemma 2.

Let ƒ(θ) be the n+1 times differentiable function for which we want to approximate the gradient and let pₙ(θ) be the degree n Lagrange interpolation polynomial for points {θ₁, θ₂, . . . , θₖ, . . . , θₙ}. The gradient evaluated at point θₖ is then given by the interpolation polynomial

$$\frac{\partial p ( {θ}_{k} )}{\partial θ} = {\sum }_{j = 0}^{n} f ( {θ}_{j} ) {ℒ}_{n , j}^{′} ( {θ}_{k} ) , \qquad ( 74 )$$

where [symbol] _{n,j}′ is the derivative of the Lagrange interpolation polynomials

$${ℒ}_{μ , j} ( θ ) := {\prod }_{{k = 0}_{k \neq j}}^{μ} \frac{θ - {θ}_{k}}{{θ}_{j} - {θ}_{k}} , \qquad$$

and the error is given by

$$\vert \frac{\partial f ( {θ}_{k} )}{\partial θ} - \frac{\partial {p}_{n} ( {θ}_{k} )}{\partial θ} \vert \leq \frac{1}{( n + 1 ) !} \vert {f}^{( n + 1 )} ( ξ ( {θ}_{k} ) ) {\prod }_{{j = 0}_{j \neq k}}^{n} ( {θ}_{j} - {θ}_{k} ) \vert , \qquad ( 75 )$$

where ξ(θₖ) is a constant depending on the point θₖ at which the gradient is evaluated, and where ƒ⁽ⁱ⁾ denotes the i-th derivative of ƒ. Note that θ is a point within the set of points at which evaluation is attempted.

Proof.

Recall that the error for the degree n Lagrange interpolation polynomial is given by

$$f ( θ ) - {p}_{n} ( θ ) \leq \frac{1}{( n + 1 ) !} {f}^{( n + 1 )} ( {ξ}_{θ} ) w ( θ ) , \qquad ( 76 )$$

where

$$w ( θ ) := {\prod }_{j = 1}^{n} ( θ - {θ}_{j} ) .$$

It is necessary to estimate the gradient of this, and hence to evaluate

$$\frac{\partial f ( θ )}{\partial θ} - \frac{\partial {p}_{n} ( θ )}{\partial θ} \leq {lim}_{Δ -> 0} ( \frac{\frac{1}{( n + 1 ) !} {f}^{( n + 1 )} ( {ξ}_{θ + Δ} ) w ( θ + Δ ) - \frac{1}{( n + 1 ) !} {f}^{( n + 1 )} ( {ξ}_{θ} ) w ( θ )}{Δ} ) . \qquad ( 77 )$$

Now, since it is not necessary to estimate the gradient at an arbitrary point θ, but sufficient to estimate the gradient at a chosen point, it is possible to set θ to be one of the points at which the function ƒ(θ), i.e., θ∈{θᵢ}ᵢ₌₁ⁿ, is evaluated. Let this choice be given by θₖ, arbitrarily chosen. Then the latter term vanishes since w(θₖ)=0. Therefore,

$$\frac{\partial f ( {θ}_{k} )}{\partial θ} - \frac{\partial {p}_{n} ( {θ}_{k} )}{\partial θ} \leq {lim}_{Δ \to 0} ( \frac{\frac{1}{( n + 1 ) !} {f}^{( n + 1 )} ( {ξ}_{{θ}_{k} + Δ} ) w ( {θ}_{k} + Δ )}{Δ} ) , \qquad ( 78 )$$

and noting that w(θₖ) contains one term (θₖ+Δ−θₖ)=Δ achieves the claimed result.

A number of approximation steps will be performed in order to obtain a form which can be simulated on a quantum computer more efficiently, and only then resolve to divided differences at this “lower level”. In detail the following steps are performed. Recalling the need to evaluate the gradient of

$$Tr [ \frac{\partial }{\partial θ} ρ log ( {σ}_{v} ) ] ,$$

1. The logarithm is first approximated via a Fourier-like approximation, i.e.,

log σᵥ→log_{K,M}σᵥ, (79)
similar to [3], which will yield a Fourier-like series in terms of σᵥ, i.e., Σₘcₘ exp (imπσᵥ).
2. Next, it is necessary to evaluate the gradient of the function

$$Tr [ \frac{\partial }{\partial θ} ρ {log}_{K , M} ( {σ}_{v} ) ] ,$$

where log(σᵥ) is now approximated with the truncated Fourier series up to order K, using an additional parameter M which will be explained below. Taking the derivative yields many terms of the form

$${\int }_{0}^{1} d s {e}^{( i s m π {σ}_{v} )} \frac{\partial {σ}_{v}}{\partial θ} {e}^{( i ( 1 - s ) m π {σ}_{v} )} , \qquad ( 80 )$$

as a result of the Duhamel's formula. Note that this derivative is exact except the approximation error of the logarithm. Each term in this expansion can furthermore be evaluated separately via a sampling procedure, i.e.,

$${\int }_{0}^{1} d s {e}^{( i s m π {σ}_{v} )} \frac{\partial {σ}_{v}}{\partial θ} {e}^{( i ( 1 - s ) m π {σ}_{v} )} \approx {𝔼}_{s} [ {e}^{( i s m π {σ}_{v} )} \frac{\partial {σ}_{v}}{\partial θ} {e}^{( i ( 1 - s ) m π {σ}_{v} )} ] , \qquad ( 81 )$$

and there is now only a logarithmic number of terms, so the result can be combined via classical postprocessing once the trace is evaluated.
3. Next, a divided difference scheme is applied to approximate the gradient

$$\frac{\partial {σ}_{v}}{\partial θ} , \qquad$$

which results in a polynomial of order n (i.e., the number of points at which the function is evaluated) in σᵥ, which we can be evaluated efficiently.
4. However, evaluating these terms is still not trivial. The final step consists hence of implementing a routine that allows evaluation of these terms on a quantum device. In order to do so, one again makes use of the Fourier series approach. Applied this time is the simple idea of approximating the density operator σᵥ by the series of itself, i.e., σᵥ≈F(σᵥ):=Σ_{m′}c_{m′}exp (imπm′σᵥ), which can be implemented conveniently via sample based Hamiltonian simulation [ ].

The following provides concrete bounds on the error introduced by the approximations and details of the implementation. The final result is then stated in Theorem 4. First one bounds the error in the approximation of the logarithm and then uses Lemma 37 of [3] to obtain a Fourier series approximation which is close to log(z). The Taylor series of

for x∈(0,1) and where

$$\begin{matrix}log ( x ) = {\sum }_{k = 1}^{∞} {( - 1 )}^{k + 1} \frac{{( x - 1 )}^{k}}{k} \\ = {\sum }_{k = 1}^{{K}_{1}} {( - 1 )}^{k + 1} \frac{{( x - 1 )}^{k}}{k} + {R}_{{K}_{1} + 1} ( x - 1 ) ,\end{matrix} \qquad ( 82 )$$

for x 6 (0.1) and where

$${R}_{K + 1} ( z ) = \frac{{f}^{{K}_{1} + 1} ( c )}{K !} {( z - c )}^{{K}_{1}} z$$

is the Cauchy remainder of the Taylor series, for −1<z<0. The error can hence be bounded as

$$\vert {R}_{{K}_{1} + 1} ( z ) \vert = \vert {( - 1 )}^{{K}_{1}} \frac{{{z}^{{K}_{1} + 1} ( 1 - α )}^{{K}_{1}}}{{( 1 + α z )}^{{K}_{1} + 1}} \vert , \qquad ( 83 )$$

where the derivatives of the logarithm are evaluated, and where 0≤α≤1 is a parameter. Using that 1+αz≥1+z (since z≤0) and hence

$$0 \leq \frac{1 - α}{1 + α z} \leq 1 ,$$

the error bound becomes

$$\vert {R}_{{K}_{1} + 1} ( z ) \vert \leq \frac{{\vert z \vert}^{{K}_{1} + 1}}{1 + z} \qquad ( 84 )$$

Reversing to the variable x the error bound for the Taylor series, and assuming that 0<δₗ<z and 0<|−z|≤δᵤ<1, which is justified when dealing with sufficiently mixed states, then the approximation error is given by

$$\vert {R}_{{K}_{1} + 1} ( z ) \vert \leq \frac{{( {δ}_{l} )}^{{K}_{1} + 1}}{{δ}_{u}} {\leq }^{!} {ϵ}_{1} . \qquad ( 85 )$$

Hence in order to achieve the desired error ϵ₁ we need

$${K}_{1} \geq \frac{log ( {( {ϵ}_{1} {δ}_{u} )}^{- 1} )}{log ( {( {δ}_{l} )}^{- 1} )} . \qquad ( 86 )$$

Hence, it is possible to choose K₁ such that the error in the approximation of the Taylor series is ≤ϵ₁/4. This implies the ability to make use of Lemma 37 of [3], and therefore to obtain a Fourier series approximation for the logarithm. This Lemma is now restated here for completeness:

Lemma 3.

(Lemma 37 in [3]) Let ƒ: [symbol] → [symbol] and δ,ϵ∈(0,1), and T(ƒ):=Σₖ₌₀^{K}aₖx^{k} be a polynomial such that |ƒ(x)−T(ƒ)|≤ϵ/4 for all x∈[−1+δ,1−δ]. Then ∃c∈ [symbol] ^{2M+1}.

$$\vert f ( x ) - {\sum }_{m = - M}^{M} {c}_{m} {e}^{\frac{i π m}{2} x} \vert \leq ϵ \qquad ( 87 )$$

for all x∈[−1+δ,1−], where

$$M = max ( 2 ⌈ ln ( \frac{4 {‖ a ‖}_{1}}{ϵ} ) \frac{1}{δ} ] , 0 )$$

and ∥c∥₁≤∥a∥₁. Moreover, c can be efficiently calculated on a classical computer in time poly(K,M,log(1/ϵ)).

In order to apply this lemma to the present case, the approximation rate is now restricted to the range (δₗ,δᵤ), where 0<δₗ≤δᵤ<1. Therefore over this range an approximation of the following form is obtained.

Corollary 1.

Let ƒ: [symbol] → [symbol] be defined as ƒ(x)=log(x), δ,ϵ₁∈(0,1), and

$${log}_{K} ( 1 - x ) := {\sum }_{k = 1}^{{K}_{1}} \frac{{( - 1 )}^{k - 1}}{k} {x}^{k}$$

such that

$${a}_{k} : = \frac{{( - 1 )}^{k - 1}}{k}$$

and

$${‖ a ‖}_{1} = {\sum }_{k = 1}^{{K}_{1}} \frac{1}{k}$$

with

$${K}_{1} \geq \frac{log ( 4 {( {ϵ}_{1} {δ}_{1}^{u} )}^{- 1} )}{log ( {( {δ}_{l} )}^{- 1} )}$$

such that |log(x)−log_{K}(x)|≤ϵ₁/4 for all x∈[δₗ,δᵤ]. Then ∃c∈ [symbol] ^{2M+1}.

$$\vert f ( x ) - {\sum }_{m = - {M}_{1}}^{{M}_{1}} {c}_{m} {e}^{\frac{i π m}{2} x} \vert \leq {ϵ}_{1} \qquad ( 88 )$$

for all x∈[δₗ,δᵤ], where

$${M}_{1} = max ( 2 ⌈ ln ( \frac{4 {‖ a ‖}_{1}}{{ϵ}_{1}} ) \frac{1}{1 - {δ}_{u}} ⌉ , 0 )$$

and ∥c∥₁≤∥a∥₁. Moreover, c can be efficiently calculated on a classical computer in time poly(K₁, M₁, log(1/ϵ₁)).

Proof.

The proof follows straightforwardly by combining Lemma 3 with the approximation of the logarithm and the range over which we want to approximate the function.

In the following

$${log}_{K , M} ( x ) := {\sum }_{m = - {M}_{1}}^{{M}_{1}} {c}_{m} {e}^{\frac{i π m}{2} x} ,$$

where the K-subscript is retained to denote that classical computation of this approximation is poly(K)-dependent. Now the gradient of the objective is expressed via this approximation as

$$Tr [ \frac{\partial }{\partial θ} ρ {log}_{K , M} {σ}_{v} ] \approx {\sum }_{m = - {M}_{1}}^{{M}_{1}} \frac{i {c}_{m} m π}{2} {\int }_{0}^{1} dsTr [ ρ {e}^{\frac{i s π m}{2} {σ}_{v}} \frac{\partial {σ}_{v}}{\partial θ} {e}^{\frac{i ( 1 - s ) π m}{2} {σ}_{v}} ] . \qquad ( 89 )$$

where each term in the sum may be evaluated individually and the results classically post-processed, i.e., sumed up. In particular the latter can be evaluated as the expectation value over s, i.e.,

$${\int }_{0}^{1} dsTr [ ρ {e}^{\frac{i s π m}{2} {σ}_{v}} \frac{\partial {σ}_{v}}{\partial θ} {e}^{\frac{i ( 1 - s ) π m}{2} {σ}_{v}} ] = {𝔼}_{s ∈ [ 0 , 1 ]} [ Tr [ ρ {e}^{\frac{i s π m}{2} {σ}_{v}} \frac{\partial {σ}_{v}}{\partial θ} {e}^{\frac{i ( 1 - s ) π m}{2} {σ}_{v}} ] ] , \qquad ( 90 )$$

which can be evaluated separately on a quantum device. In the following it is necessary to devise a method to evaluate this expectation value.

First, the gradient is expanded using a divided difference formula such that

$$\frac{\partial {σ}_{v}}{\partial θ}$$

is approximated by the Lagrange interpolation polynomial of degree μ−1, i.e.,

$$\begin{matrix}\frac{\partial {σ}_{v}}{\partial θ} ( θ ) \approx {\sum }_{j = 0}^{μ} {σ}_{v} ( {θ}_{j} ) {ℒ}_{μ , j}^{′} ( θ ) , \\ where & ( 91 ) \\ {ℒ}_{μ , j} ( θ ) := {\prod }_{{k = 0}_{k \neq j}}^{μ} \frac{θ - {θ}_{k}}{{θ}_{j} - {θ}_{k}} . & ( 92 )\end{matrix}$$

Note that the order p is free to chose, and will guarantee a different error in the solution of the gradient estimate as described prior in Lemma 2. Using this in the gradient estimation, a polynomial of the form is obtained (evaluated at θⱼ, i.e., the chosen points)

$${\sum }_{m = - {M}_{1}}^{{M}_{1}} \frac{i {c}_{m} m π}{2} {\sum }_{j = 0}^{μ} {ℒ}_{μ , j}^{′} ( {θ}_{j} ) {𝔼}_{s ∈ [ 0 , 1 ]} [ Tr [ ρ {e}^{\frac{i s π m}{2} {σ}_{v}} {σ}_{v} ( {θ}_{j} ) {e}^{\frac{i ( 1 - s ) π m}{2} {σ}_{v}} ] ] , \qquad ( 93 )$$

where each term again can be evaluated separately, and efficiently combined via classical post-processing. Note that the error in the Lagrange interpolation polynomial decreases exponentially fast, and therefore the number of terms we use is sufficiently small to do so. Next, it is necessary to deploy a method to evaluate the above expressions. In order to do so, σᵥ is implemented as a Fourier series of itself, i.e., σᵥ=arcsin(sin(σᵥπ/2)/(π/2)), which will then be approximated in a similar approach as taken in Lemma 3. With this the following result is obtained.

Lemma 4.

Let δ, ϵ₂∈(0,1), and \tilde{x}:=Σ_{m′=-M}_{₂}^{M}^{₂}\tilde{c}_{m′}e^{iπm′x/2} with

$${K}_{2} \geq \frac{log ( 4 / {ϵ}_{2} )}{log ( {δ}_{u}^{- 1} )} and$$

$${M}_{2} \geq ⌈ log ( \frac{4}{{ϵ}_{2}} ) \sqrt{{( 2 log {δ}_{u}^{- 1} )}^{- 1}} ⌉$$

and x∈[δₗ,δᵤ]. Then ∃\tilde{c}∈ [symbol] ^{2M+1}:

|x−\tilde{x}|≤ϵ₂ (94)

for all x∈[δₗ,δᵤ], and ∥c∥₁≤1. Moreover, \tilde{c} can be efficiently calculated on a classical computer in time poly(K₂, M₂, log(1/ϵ₂)).

Proof.

Invoking the technique used in [3], we expand

$$arcsin ( z ) = {\sum }_{k = 0}^{{K}_{2}} {2}^{- 2 {k}^{′}} ( \begin{matrix}2 {k}^{′} \\ k\end{matrix} ) \frac{{z}^{2 {k}^{′} + 1}}{2 {k}^{′} + 1} + {R}_{{K}_{2} + 1} ( z ) , \qquad ( 95 )$$

where R_{K}_{₂}₊₁ is the remainder as before. For 0<z≤δᵤ≤½, remainder can be bound by

$$\vert {R}_{{K}_{2} + 1} \vert \leq \frac{{\vert {δ}_{u} \vert}^{{K}_{2} + 1}}{1 / 2} {\leq }^{!} {ɛ}_{2} / 2 ,$$

which gives the bound

$${K}_{2} \geq \frac{log ( 4 / {ϵ}_{2} )}{log ( {δ}_{u}^{- 1} )} . \qquad ( 96 )$$

By approximation,

$${sin}^{l} ( x ) = {( \frac{i}{2} )}^{l} {\sum }_{{m}^{′} = 0}^{l} {( - 1 )}^{{m}^{′}} ( \begin{matrix}l \\ {m}^{′}\end{matrix} ) {e}^{i x ( 2 {m}^{′} - l )} \qquad ( 97 )$$

by

$${sin}^{l} ( x ) \approx {( \frac{i}{2} )}^{l} {\sum }_{{m}^{′} = ⌈ l / 2 ⌉ - {M}_{2}}^{⌊ l / 2 ⌋ + {M}_{2}} {( - 1 )}^{{m}^{′}} ( \begin{matrix}l \\ {m}^{′}\end{matrix} ) {e}^{i x ( 2 {m}^{′} - l )} , \qquad ( 98 )$$

which induces an error of ϵ₂/2 for the choice

$${M}_{2} \geq ⌈ log ( \frac{4}{{ϵ}_{2}} ) \sqrt{{( 2 log {δ}_{u}^{- 1} )}^{- 1}} ⌉ . \qquad ( 99 )$$

This can be seen by using Chernoff's inequality for sums of binomial coefficients, i.e.,

$${\sum }_{{m}^{′} = ⌈ l / 2 + {M}_{2} ⌉}^{l} {2}^{- l} ( \begin{matrix}l \\ {m}^{′}\end{matrix} ) \leq {e}^{- \frac{2 {M}_{2}^{2}}{l}} , \qquad ( 100 )$$

and choosing M appropriately. Finally, defining ƒ(z):=arcsin(sin(zπ/2)/(π/2)), as well as \tilde{ƒ}₁:=Σ_{k′=0}^{K}^{₂}b_{k′} sin^{2k′+1}(zπ/2) and

$${\tilde{f}}_{2} ( z ) : = {\sum }_{{k}^{′} = 0}^{{K}_{2}} {{b}_{{k}^{′}} ( \frac{i}{2} )}^{l} {\sum }_{{m}^{′} = ⌈ l / 2 ⌉ - {M}_{2}}^{⌊ l / 2 ⌋ + {M}_{2}} {( - 1 )}^{{m}^{′}} ( \begin{matrix}l \\ {m}^{′}\end{matrix} ) {e}^{i x ( 2 {m}^{′} - l )} , \qquad ( 101 )$$

and observing that

∥ƒ−\tilde{ƒ}₂∥_{∞}≤∥ƒ−\tilde{ƒ}₁∥_{∞}+∥\tilde{ƒ}₁−\tilde{ƒ}₂∥_{∞}, (102)

yields the final error of ϵ₂ for the approximation z≈\tilde{z}=Σ_{m′}\tilde{c}_{m′}e^{iπm′z/2}.

Note that this immediately leads to an ϵ₂ error in the spectral norm for the approximation

$${‖ {σ}_{υ} - {\sum }_{{m}^{′} = - {M}_{2}}^{{M}_{2}} {\tilde{c}}_{{m}^{′}} {e}^{i π {m}^{′} {σ}_{υ} / 2} ‖}_{2} \leq {ϵ}_{2} , \qquad ( 103 )$$

where σᵥ is the reduced density matrix.

Since the final goal is to estimate Tr [∂_{θ}ρ log σᵥ], with a variety of σᵥ(θⱼ) using the divided difference approach, it is also necessary to bound the error in this estimate which is now introduced with the above approximations. Bounding the derivative with respect to the remainder can be done by using the truncated series expansion and bounding the gradient of the remainder. This yields the following result.

Lemma 5.

For the of the parameters M₁, M₂, K₁, L, μ, Δ, s given in Eq. (143-150), and ρ, σᵥ being two density matrices, we can estimate the gradient of the relative entropy such that

|∂_{θ}Tr[ρ log σᵥ]−∂_{θ}Tr[ρ log_{K}_{₁}_{,M}_{₁}\tilde{σ}ᵥ]|≤ϵ, (104)

where the function ∂_{θ}Tr [ρ log_{K}_{₁}_{,M}_{₁}\tilde{σ}ᵥ] evaluated at θ is defined as

$$Re [ {\sum }_{m = - {M}_{1}}^{{M}_{1}} {\sum }_{{m}^{′} = - {M}_{2}}^{{M}_{2}} \frac{i {c}_{m} {\tilde{c}}_{{m}^{′}} m π}{2} {\sum }_{j = 0}^{μ} {ℒ}_{μ , j}^{′} ( θ ) {𝔼}_{s ∈ [ 0 , 1 ]} [ Tr [ ρ {e}^{\frac{i s π m}{2} {σ}_{υ}} {e}^{\frac{i π {m}^{′}}{2} {σ}_{υ} ( {θ}_{j} )} {e}^{\frac{i ( 1 - s ) π m}{2} {σ}_{υ}} ] ] ] \qquad ( 105 )$$

The gradient can hence be approximated to error ϵ with O(poly(M₁, M₂, K₁, L, s, Δ, μ)) computation on a classical computer and using only the Hadamard test, Gibbs state preparation and LCU on a quantum device.

Notably the expression in Eq. 105 can now be evaluated with a quantum-classical hybrid device by evaluating each term in the trace separately via a Hadamard test and, since the number of terms is only polynomial, and then evaluating the whole sum efficiently on a classical device.

Proof.

For the proof we perform the following steps. Let σᵢ(ρ) be the singular values of ρ, which are equivalently the eigenvalues since ρ is Hermitian. Then observe that the gradient can be separated in different terms, i.e., let log_{K}_{₁}_{,M}_{₁}^{s}σᵥ be the approximation as given above for a finite sample of the expectation values [symbol] ₛ, then

$$\vert {\partial }_{θ} Tr [ ρlog {σ}_{υ} ] - {\partial }_{θ} Tr [ ρ {log}_{{K}_{1} , {M}_{1}}^{s} {\tilde{σ}}_{υ} ] \vert \leq \leq {\sum }_{i} {σ}_{i} ( ρ ) \cdot ‖ {\partial }_{θ} [ log {σ}_{υ} - {log}_{{K}_{1} , {M}_{1}}^{s} {\tilde{σ}}_{υ} ] ‖ \leq {\sum }_{i} {σ}_{i} ( ρ ) \cdot ( ‖ {\partial }_{θ} [ log {σ}_{υ} - {log}_{{K}_{1} , {M}_{1}} {σ}_{υ} ] ‖ + ‖ {\partial }_{θ} [ {log}_{{K}_{1} , {M}_{1}} {σ}_{υ} - {log}_{{K}_{1} , {M}_{1}} {\tilde{σ}}_{υ} ] ‖ + ‖ {\partial }_{θ} [ {log}_{{K}_{1} , {M}_{1}} {\tilde{σ}}_{υ} - {log}_{{K}_{1} , {M}_{1}}^{s} {\tilde{σ}}_{υ} ] ‖ ) \qquad ( 106 )$$

where the second step follows from the Von-Neumann trace inequality and the terms are (1) the error in approximating the logarithm, (2) the error introduced by the divided difference and the approximation of σᵥ as a Fourier-like series, and (3) is the finite sampling approximation error. It is now possible to bound the different terms separately, and to start with the first part which is in general harder to estimate. The bound is partitioned into three terms, corresponding to the three different approximations taken above.

$$\begin{matrix} ‖ {\partial }_{θ} [ log {σ}_{υ} - {log}_{{K}_{1} , {M}_{1}} {σ}_{υ} ] ‖ \leq & ( 107 ) \\ \leq ‖ {\partial }_{θ} {\sum }_{k = {K}_{1} + 1}^{∞} \frac{{( - 1 )}^{k}}{k} {σ}_{υ}^{k} ‖ + ‖ {\partial }_{θ} {\sum }_{k = 1}^{{K}_{1}} \frac{{( - 1 )}^{k}}{k} {\sum }_{l = L}^{∞} {b}_{l}^{( k )} {sin}^{l} ( {σ}_{υ} π \text{/} 2 ) ‖ & ( 108 ) \\ + ‖ {\partial }_{θ} {\sum }_{k = 1}^{{K}_{1}} \frac{{( - 1 )}^{k}}{k} {\sum }_{l = L}^{∞} {{b}_{l}^{( k )} ( \frac{1}{2} )}^{l} {\sum }_{m ∈ [ 0 , ⌈ l / 2 ⌉ - {M}_{1} ] ⋃ [ ⌊ l / 2 ⌋ + {M}_{1} , l ]}^{ } {( - 1 )}^{m} {e}^{i ( 2 m - l ) {σ}_{υ} π / 2} ‖ & ( 109 )\end{matrix}$$

The first term can be bound in the following way:

$$\leq {\sum }_{k = {K}_{1} + 1}^{∞} {‖ {σ}_{υ} ‖}^{k - 1} = \frac{{‖ {σ}_{υ} ‖}^{{K}_{1}}}{1 - ‖ {σ}_{υ} ‖} , \qquad ( 110 )$$

and, assuming ∥σᵥ∥<1, we hence can set

K₁≥log((1−∥σᵥ∥)ϵ/9)/log(∥σᵥ∥) (111)

appropriately in order to achieve an ϵ/9 error. The second term can be bound by assuming that ∥σᵥπ∥<1, and choosing

$$L \geq log \frac{( \frac{ϵ}{9 π K ‖ \frac{\partial {σ}_{υ}}{\partial θ} ‖} )}{log ( ‖ {σ}_{υ} ‖ π )} , \qquad ( 112 )$$

which we derive by observing that

$$\begin{matrix}\leq {\sum }_{k = 1}^{K} \frac{1}{k} {\sum }_{l = L}^{∞} {b}_{l}^{( k )} l ‖ {sin}^{l - 1} ( {σ}_{υ} π / 2 ) ‖ \cdot ‖ \frac{π}{2} \frac{\partial {σ}_{υ}}{\partial θ} ‖ & ( 113 ) \\ < {\sum }_{k = 1}^{K} \frac{1}{k} {\sum }_{l = L + 1}^{∞} {b}_{l}^{( k )} π {‖ {σ}_{υ} π ‖}^{l - 1} \cdot ‖ \frac{\partial {σ}_{υ}}{\partial θ} ‖ & ( 114 ) \\ \leq {\sum }_{k = 1}^{K} \frac{1}{k} π {‖ {σ}_{υ} π ‖}^{L} \cdot ‖ \frac{\partial {σ}_{υ}}{\partial θ} ‖ , & ( 115 )\end{matrix}$$

where l<2^{l} is used in the second step. Finally, the last term can be bound similarly, which yields

$$\begin{matrix}\leq {\sum }_{k = 1}^{K} \frac{1}{k} {\sum }_{l = 1}^{L} {b}_{l}^{( k )} {e}^{- 2 {( {M}_{1} )}^{2} / l} \cdot l \cdot \frac{π}{2} ‖ \frac{\partial {σ}_{υ}}{\partial θ} ‖ & ( 116 ) \\ \leq {\sum }_{k = 1}^{K} \frac{L}{k} {\sum }_{l = 1}^{L} {b}_{l}^{( k )} {e}^{- 2 {( {M}_{1} )}^{2} \text{/} L} \frac{π}{2} ‖ \frac{\partial {σ}_{υ}}{\partial θ} ‖ & ( 117 ) \\ \leq {\sum }_{k = 1}^{K} \frac{L}{k} {e}^{- 2 {( {M}_{1} )}^{2} \text{/} L} \frac{π}{2} ‖ \frac{\partial {σ}_{υ}}{\partial θ} ‖ \leq \frac{K L π}{2} {e}^{- 2 {( {M}_{1} )}^{2} \text{/} L} ‖ \frac{\partial {σ}_{υ}}{\partial θ} ‖ , & ( 118 )\end{matrix}$$

and we can hence chose

$${M}_{1} \geq \sqrt{L log ( \frac{9 ‖ \frac{\partial {σ}_{υ}}{\partial θ} ‖ {K}_{1} L π}{2 ϵ} )} \qquad ( 119 )$$

in order to decrease the error to e/3 for the first term in Eq. 106.
For the second term, first note that with the notation chosen, ∥∂_{θ}[log_{K}_{₁}_{,M}_{₁}σᵥ−log_{K}_{₁}_{,M}_{₁}\tilde{σ}ᵥ]∥ is the difference between the log-approximation where the gradient of σᵥ is still exact, i.e., Eq. 89, and the version where the gradient is approximated via divided differences and the linear combination of unitaries, given in Eq. 105. Recall that the first level approximation was given by

$${\sum }_{m = - {M}_{1}}^{{M}_{1}} \frac{i {c}_{m} m π}{2} {\int }_{0}^{1} ds Tr [ ρ {e}^{\frac{i s π m}{2} {σ}_{υ}} \frac{\partial {σ}_{υ}}{\partial θ} {e}^{\frac{i ( 1 - s ) π m}{2} {σ}_{υ}} ] , \qquad ( 120 )$$

where one returns from the expectation value formulation back to the integral formulation to avoid consideration of potential errors due to sampling.

Bounding the difference hence yields one term from the divided difference approximation of the gradient and an error from the Fourier series, which are both bounded separately. Denoting ∂\tilde{p}(θₖ)/∂θ as the divided difference and the LCU approximation of the Fourier series¹, and with ∂p(θₖ)/∂θ the divided difference without approximation via the Fourier series, ¹ which effectively means that the coefficients of the interpolation polynomial are approximated

$$\begin{matrix} ‖ {\partial }_{θ} [ {log}_{{K}_{1} , {M}_{1}} {σ}_{υ} - {log}_{{K}_{1} , {M}_{1}} {\tilde{σ}}_{υ} ] ‖ \leq & ( 121 ) \\ \leq \vert {\sum }_{m = - {M}_{1}}^{{M}_{1}} \frac{i {c}_{m} m π}{2} {\int }_{0}^{1} ds Tr [ ρ {e}^{\frac{i s π m}{2} {σ}_{υ}} ( \frac{\partial {σ}_{υ}}{\partial θ} - \frac{\partial \tilde{p} ( {θ}_{k} )}{\partial θ} ) {e}^{\frac{i ( 1 - s ) π m}{2} {σ}_{υ}} ] \vert & ( 122 ) \\ \leq \frac{{M}_{1} π {‖ a ‖}_{1}}{2} {\int }_{0}^{1} d s {\sum }_{i} {σ}_{i} ( ρ ) ‖ \frac{\partial {σ}_{υ}}{\partial θ} - \frac{\partial \tilde{p} ( {θ}_{k} )}{\partial θ} ‖ & ( 123 ) \\ \leq \frac{{M}_{1} π {‖ a ‖}_{1}}{2} {\int }_{0}^{1} d s {\sum }_{i} {σ}_{i} ( ρ ) ( ‖ \frac{\partial {σ}_{υ}}{\partial θ} - \frac{\partial p ( {θ}_{k} )}{\partial θ} ‖ + ‖ \frac{\partial p ( {θ}_{k} )}{\partial θ} - \frac{\partial \tilde{p} ( {θ}_{k} )}{\partial θ} ‖ ) & ( 124 ) \\ \leq \frac{{M}_{1} {‖ a ‖}_{1} π}{2} {\int }_{0}^{1} d s {\sum }_{i} {σ}_{i} ( ρ ) ( ‖ \frac{{\partial }^{μ + 1} {σ}_{υ}}{\partial {θ}^{μ + 1}} ‖ {( \frac{Δ}{μ - 1} )}^{μ} \frac{{max}_{k} ( μ - k ) !}{( μ + 1 ) !} + {\sum }_{j = 0}^{μ} \vert {ℒ}_{μ , j}^{′} ( {θ}_{j} ) \vert ‖ {σ}_{υ} - {\tilde{σ}}_{υ} ‖ ) & ( 125 ) \\ \leq \frac{{M}_{1} {‖ a ‖}_{1} π}{2} ( ‖ \frac{{\partial }^{μ + 1} {σ}_{υ}}{\partial {θ}^{μ + 1}} ‖ {( \frac{Δ}{μ - 1} )}^{μ} \frac{μ !}{( μ + 1 ) !} + μ {‖ {ℒ}_{μ , j}^{′} ( {θ}_{j} ) ‖}_{∞} {ϵ}_{2} ) , & ( 126 )\end{matrix}$$

where ∥a∥₁=Σₖ₌₁^{K}^{₁}/k, and in the last step the results of Lemma 4 are used. Under appropriate assumptions on the grid-spacing for the divided difference scheme Δ and the number of evaluated points p as well as a bound on the μ+1-st derivative of σᵥ w.r.t. θ, it is now possible to also bound this error. In order to do so, it is necessary to analyze the μ+1-st derivative of σᵥ=Trₕ [e^{-H}]/Z with Z=Tr [e^{-H}]. For this,

$$‖ \frac{{\partial }^{μ + 1} {σ}_{υ}}{\partial {θ}^{μ + 1}} ‖ \leq {\sum }_{p = 1}^{μ + 1} ( \begin{matrix}μ + 1 \\ p\end{matrix} ) ‖ \frac{{\partial }^{p} T {r}_{h} [ {e}^{- H} ]}{\partial {θ}^{p}} ‖ ‖ \frac{{\partial }^{μ + 1 - p} {Z}^{- 1}}{\partial {θ}^{μ + 1 - p}} ‖ \leq {2}^{μ + 1} {max}_{p} ‖ \frac{{\partial }^{p} T {r}_{h} [ {e}^{- H} ]}{\partial {θ}^{p}} ‖ ‖ \frac{{\partial }^{μ + 1 - p} {Z}^{- 1}}{\partial {θ}^{μ + 1 - p}} ‖ \qquad ( 127 )$$

Also,

$$‖ \frac{{\partial }^{p} T {r}_{h} [ {e}^{- H} ]}{\partial {θ}^{p}} ‖ \leq dim ( {H}_{h} ) ‖ \frac{{\partial }^{q} {e}^{- H}}{\partial {θ}^{q}} ‖ \qquad ( 128 )$$

where dim(Hₕ)=2ⁿ^{ₕ}. In order to bound this, the infinitesimal expansion of the exponent is employed, i.e.,

$$\begin{matrix}‖ \frac{{\partial }^{q} {e}^{- H}}{\partial {θ}^{q}} ‖ = ‖ \frac{{\partial }^{q}}{\partial {θ}^{q}} {lim}_{r \to ∞} {\prod }_{j = 1}^{r} {e}^{- H / r} ‖ \\ = ‖ {lim}_{r \to ∞} ( \frac{{\partial }^{q} {e}^{- H / r}}{\partial {θ}^{q}} {\prod }_{j = 2}^{r} {e}^{- H / r} + \\ \frac{{\partial }^{q - 1} {e}^{- H / r}}{\partial {θ}^{q - 1}} \frac{\partial {e}^{- H / r}}{\partial θ} {\prod }_{j = 3}^{r} {e}^{- H / r} + … ) ‖ \\ \leq {lim}_{r \to ∞} ‖ {( \frac{\partial H / r}{\partial θ} ‖}^{q} \cdot {r}^{q} + O ( \frac{1}{r} ) ) ‖ {e}^{- H} ‖ \\ = {‖ \frac{\partial H}{\partial θ} ‖}^{q} ‖ {e}^{- H} ‖ ,\end{matrix} \qquad ( 129 )$$

where the last step follows from the r^{q} terms and that the error introduced by the commutations above will be of O(1/r). Observing that ∂_{θ}_{ᵢ}H=∂_{θ}_{ᵢ}ΣⱼθⱼHⱼ=Hᵢ and assuming that λₘₐₓ is the largest singular eigenvalue of H, this can be bounded by λₘₐₓ^{q}∥e^{-H}∥.

$$\begin{matrix}\begin{matrix}‖ \frac{{\partial }^{p} T {r}_{h} [ {e}^{- H} ]}{\partial {θ}^{p}} ‖ \leq dim ( {H}_{h} ) ‖ \frac{{\partial }^{q} {e}^{- H}}{\partial {θ}^{q}} ‖ \\ \leq {λ}_{max}^{p} dim ( {H}_{h} ) ‖ {T}_{T} r [ {e}^{- H} ] ‖\end{matrix} & ( 130 ) \\ \begin{matrix}‖ \frac{{\partial }^{μ + 1 - p} {Z}^{- 1}}{\partial {θ}^{μ + 1 - p}} ‖ \leq \frac{( μ + 1 - p ) ! \vert {λ}_{max} {\vert}^{μ + 1 - p}}{{Z}^{μ + 2 - p}} Tr [ {e}^{- H} ] \\ \leq {( \frac{μ + 1 - p}{e Z} )}^{μ + 1 - p} \frac{e}{Z} {\vert {λ}_{max} \vert}^{μ + 1 - p} T r [ {e}^{- H} ] \\ = {( \frac{μ + 1 - p}{e Z} )}^{μ + 1 - p} e {\vert {λ}_{max} \vert}^{μ + 1 - p}\end{matrix} & ( 131 )\end{matrix}$$

We can therefore find a bound for Eq. 127 as

$$‖ \frac{{\partial }^{μ + 1} {σ}_{υ}}{\partial {θ}^{μ + 1}} ‖ \leq e {2}^{μ + 1 + {n}_{h}} {λ}_{max}^{μ + 1} ‖ {Tr}_{h} [ {e}^{- H} ] ‖ {max}_{p} {( \frac{μ + 1 - p}{e Z} )}^{μ + 1 - p} . \qquad ( 132 )$$

Plugging this result into the bound from above yields

$$‖ {\partial }_{θ} [ {log}_{{K}_{1} , {M}_{1}} {σ}_{υ} - {log}_{{K}_{1} , {M}_{1}} {\tilde{σ}}_{υ} ] ‖ \leq \frac{{M}_{1} {‖ a ‖}_{1} π}{2} ( e {2}^{μ + 1 + {n}_{h}} {λ}_{max}^{μ + 1} ‖ {Tr}_{h} [ {e}^{- H} ] ‖ {max}_{p} {( \frac{μ + 1 - p}{e Z} )}^{μ + 1 - p} {( \frac{Δ}{μ - 1} )}^{μ} \frac{1}{μ + 1} ) + \frac{{M}_{1} {‖ a ‖}_{1} π}{2} ( μ {‖ {ℒ}_{μ , j}^{′} ( {θ}_{j} ) ‖}_{∞} {ϵ}_{2} ) , \qquad ( 133 )$$

Note that under the reasonable assumption that 2≤μ<<Z, the maximum is achieved for p=μ+1, and hence the upper bound is

$$\frac{{M}_{1} {‖ a ‖}_{1} π}{2} ( {2}^{{n}_{h}} {e ( 2 \vert {λ}_{max} \vert )}^{μ + 1} ‖ {Tr}_{h} [ {e}^{- H} ] ‖ {( \frac{Δ}{μ - 1} )}^{μ} \frac{1}{μ + 1} + μ {‖ {ℒ}_{μ , j}^{′} ( {θ}_{j} ) ‖}_{∞} {ϵ}_{2} ) \leq \frac{{M}_{1} {‖ a ‖}_{1} π}{2} ( {2}^{{n}_{h}} {e ( 2 \vert {λ}_{max} ⌉ )}^{μ + 1} ‖ {Tr}_{h} [ {e}^{- H} ] ‖ {( \frac{Δ}{μ - 1} )}^{μ} + μ {‖ {ℒ}_{μ , j}^{′} ( {θ}_{j} ) ‖}_{∞} {ϵ}_{2} ) , \qquad ( 134 )$$

and hence a bound is obtained on μ, the grid point number, in order to achieve an error of ϵ/6>0 for the former term, which is given by

$$μ \geq ( \vert {λ}_{max} \vert Δ ) exp ( W ( \frac{log ( {2}^{{n}_{h}} \frac{\begin{matrix}6 {M}_{1} {‖ a ‖}_{1} {e}^{2} \vert {λ}_{max} \vert \\ π ‖ {Tr}_{h} [ {e}^{- H} ] ‖\end{matrix}}{ϵ} )}{2 {λ}_{max} Δ} ) ) , \qquad ( 135 )$$

where W is the Lambert function, also known as product-log function, which generally grows slower than the logarithm in the asymptotic limit. Note that μ can hence be lower bounded by

$$μ \geq {n}_{h} + log ( \frac{\begin{matrix}6 {M}_{1} {‖ a ‖}_{1} {e}^{2} \vert {λ}_{max} \vert \\ π ‖ {Tr}_{h} [ {e}^{- H} ] ‖\end{matrix}}{ϵ} ) := {n}_{h} + log ( \frac{{M}_{1} Λ}{ϵ} ) . \qquad ( 136 )$$

For convenience, ϵ is chosen such that nₕ+log(M₁Λ/ϵ) is an integer. This is done simply to avoid having to keep track of ceiling or floor functions in the following discussion where μ=nₕ+log(M₁Λ/ϵ) is chosen.

For the second part, the derivative of the Lagrangian interpolation polynomial will be bounded. First, note that

$${ℒ}_{μ , j}^{′} ( θ ) = {Σ}_{l = 0 ; l \neq j}^{μ} ( {Π}_{k = 0 ; k \neq j , l} \frac{θ - {θ}_{k}}{{θ}_{j} - {θ}_{k}} ) \frac{1}{{θ}_{j} - {θ}_{l}}$$

for a chosen discretization of the space such that θₖ−θⱼ=(k−j)Δ/μ can be bound by using a central difference formula, such that an uneven number of points may be used (i.e., one takes μ=2κ+1 for positive integer κ) and chooses the point m at which one evaluates the gradient as the central point of the mesh. Note that in this case, for μ≥5 and θₘ being the parameters at the midpoint of the stencil,

$${‖ {ℒ}_{μ , j}^{′} ‖}_{∞} \leq {\sum }_{l \neq j} {\prod }_{k \neq j , l} \frac{\vert {θ}_{m} - {θ}_{k} \vert}{\vert {θ}_{j} - {θ}_{k} \vert} \frac{1}{\vert {θ}_{l} - {θ}_{j} \vert} \leq \frac{{( κ ! )}^{2}}{{( κ ! )}^{2}} \frac{μ}{Δ} {\sum }_{l \neq j} \frac{1}{\vert l - j \vert} \leq \frac{2 μ}{Δ} {\sum }_{l = 1}^{κ} \frac{1}{l} \leq \frac{2 μ}{Δ} ( 1 + {\int }_{1}^{κ - 1} \frac{1}{l} d 𝓁 ) = \frac{2 μ}{Δ} ( 1 + log ( ( μ - 3 ) \text{/} 2 ) ) \leq \frac{5 μ}{Δ} log ( μ \text{/} 2 ) , \qquad ( 137 )$$

where the last inequality follows from the fact that μ≥5 and 1+ln(5/2)<(5/2) ln(5/2). Now, plugging in the μ from Eq. 148, this error is bound by

$${‖ {ℒ}_{μ , j}^{′} ‖}_{∞} \leq \frac{5 {n}_{h} + 5 log ( \frac{{M}_{1} Λ}{ϵ} )}{Δ} log ( {n}_{h} \text{/} 2 + log ( \frac{{M}_{1} Λ}{ϵ} ) \text{/} 2 ) = \tilde{O} ( \frac{{n}_{h} + log ( \frac{{M}_{1} Λ}{ϵ} )}{Δ} ) , \qquad ( 138 )$$

If an upper bound of ϵ/6 is desired for the second term of the error in Eq. 134, then the following is required:

$$\begin{matrix}{ϵ}_{2} \leq \frac{ϵ}{15 {M}_{1} {‖ a ‖}_{1} πμ {‖ {ℒ}_{μ , j}^{′} ( θ ) ‖}_{∞}} \\ \leq \frac{ϵΔ}{\begin{matrix}15 {M}_{1} {‖ a ‖}_{1} {π ( {n}_{h} + log ( {M}_{1} Λ \text{/} ϵ ) )}^{2} \\ log ( ( {n}_{h} \text{/} 2 ) + log ( {M}_{1} Λ \text{/} ϵ ) \text{/} 2 )\end{matrix}} \\ \leq \frac{ϵΔ}{15 {M}_{1} {‖ a ‖}_{1} π {μ}^{2} log ( ( μ - 1 ) \text{/} 2 )}\end{matrix} \qquad ( 139 )$$

Hence, the approximation error due to the divided differences and Fourier series approximation of or is bounded by ϵ/3 for the above choice of ϵ₂ and μ. This bounds the second term in Eq. 126 by ϵ/3.

Finally, it is necessary to take into account the error ∥∂_{θ}[log_{K}_{₁}_{,M}_{₁}\tilde{σ}ᵥ−log_{K}_{₁}_{,M}_{₁}⁸\tilde{σ}ᵥ] which is introduced through the sampling process, i.e., through the finite sample estimate of [symbol] ₛ[⋅] here indicated with the superscript s over the logarithm. Note that this error can be bound straightforwardly by Eq. 105. It is necessary only to bound the error introduced via the finite amount of samples we take, which is a well-known procedure. The concrete bounds for the sample error when estimating the expectation value are stated in the following lemma.

Lemma 6.

Let σₘ be the sample standard deviation of the random variable

$${\tilde{𝔼}}_{s ∈ [ 0 , 1 ]} [ Tr [ ρ {e}^{\frac{i s π m}{2} {σ}_{υ}} {e}^{\frac{i π {m}^{′}}{2} {σ}_{υ} ( {θ}_{j} )} {e}^{\frac{i ( 1 - s ) π m}{2} {σ}_{υ}} ] ] , \qquad ( 140 )$$

such that the sample standard deviation is given by

$${σ}_{k} = \frac{{σ}_{m}}{\sqrt{k}} .$$

Then with probability at least 1−δₛ, we can obtain an estimate which is within ϵₛσₘ of the mean by taking

$$k = \frac{4}{{ϵ}_{s}^{2}}$$

samples for each sample estimate and taking the median of O(log(1/δₛ)) such samples.

Proof.

From Chebyshev's inequality taking

$$k = \frac{4}{{ϵ}_{s}^{2}}$$

samples implies that with probability of at least p=¾ each of the mean estimates is within 2σₖ=ϵₛσₘ from the true mean. Therefore, using standard techniques, one takes the median of O(log(1/δₛ)) such estimates which gives with probability 1−δₛ an estimate of the mean with error at most ϵₛσₘ, which implies that the procedure must be repeated

$$O ( \frac{1}{{ϵ}_{s}^{2}} log ( \frac{1}{{δ}_{s}} ) )$$

times.

It is now possible to bound the error of the sampling step in the final estimate, denoting with ϵₛ the sample error, as

$${\sum }_{m = - {M}_{1}}^{{M}_{1}} {\sum }_{{m}^{′} = - {M}_{2}}^{{M}_{2}} \vert \frac{i {c}_{m} {c}_{{m}^{′}} m π}{2} \vert {\sum }_{j = 0}^{μ} \vert {ℒ}_{μ , j}^{′} ( θ ) \vert {ϵ}_{s} {σ}_{m} \leq \frac{5 {‖ a ‖}_{1} {M}_{1} {ϵ}_{s} {σ}_{m} π {μ}^{2} log ( \frac{μ}{2} )}{Δ} \leq \frac{ϵ}{3} , \qquad ( 141 )$$

Hence, for

$$\begin{matrix}{ϵ}_{s} \leq \frac{ϵ Δ}{15 {‖ a ‖}_{1} {M}_{1} {σ}_{m} π {μ}^{2} log ( \frac{μ}{2} )} \\ \leq \frac{ϵ Δ}{\begin{matrix}15 {M}_{1} {‖ a ‖}_{1} {σ}_{m} {π ( {n}_{h} + log ( {M}_{1} Λ \text{/} ϵ ) )}^{2} \\ log ( ( {n}_{n} \text{/} 2 ) + log ( {M}_{1} Λ \text{/} ϵ ) \text{/} 2 )\end{matrix}} \\ \leq \frac{ϵ Δ}{15 {M}_{1} {‖ a ‖}_{1} {σ}_{m} {πμ}^{2} log ( μ \text{/} 2 )}\end{matrix} \qquad ( 142 )$$

also the last term in Eq. 106 can be bounded by ϵ/3, which together results in an overall error of ϵ for the various approximation steps, which concludes the proof.

Notably all quantities which occur in these bounds are only polynomial in the number of the qubits. The lower bounds for the choice of parameters are summarized in the following inequalities (Eq. 143-150).

$$\begin{matrix}{M}_{1} \geq \sqrt{L log ( \frac{9 ‖ \frac{\partial {σ}_{υ}}{\partial θ} ‖ {K}_{1} L π}{2 ϵ} )} & ( 143 ) \\ {M}_{2} \geq ⌈ log ( \frac{4}{{ϵ}_{2}} ) \sqrt{{( 2 log {δ}_{u}^{- 1} )}^{- 1}} ⌉ & ( 144 ) \\ {K}_{1} \geq log ( ( 1 - ‖ {σ}_{υ} ‖ ) ϵ / 9 ) \text{/} log ( ‖ {σ}_{υ} ‖ ) & ( 145 ) \\ {K}_{2} \geq \frac{log ( 4 \text{/} {ϵ}_{2} )}{log ( {δ}_{u}^{- 1} )} & ( 146 ) \\ L \geq \frac{log ( \frac{ϵ}{9 π {K}_{1} ‖ \frac{\partial {σ}_{υ}}{\partial θ} ‖} )}{log ( ‖ {σ}_{υ} ‖ π )} & ( 147 ) \\ μ \geq {n}_{h} + log ( \frac{\begin{matrix}6 {M}_{1} {‖ a ‖}_{1} {e}^{2} \vert {λ}_{max} \vert \\ π ‖ {Tr}_{h} [ {e}^{- H} ] ‖\end{matrix}}{ϵ} ) := {n}_{h} + log ( {M}_{1} Λ / ϵ ) & ( 148 ) \\ \begin{matrix}{ϵ}_{2} \leq \frac{ϵ Δ}{\begin{matrix}15 {M}_{1} {‖ a ‖}_{1} {π ( {n}_{h} + log ( {M}_{1} Λ / ϵ ) )}^{2} \\ log ( ( {n}_{h} \text{/} 2 ) + log ( {M}_{1} Λ \text{/} ϵ ) \text{/} 2 )\end{matrix}} \\ \leq \frac{ϵ Δ}{15 {M}_{1} {‖ a ‖}_{1} π {μ}^{2} log ( ( μ - 1 ) \text{/} 2 )}\end{matrix} & ( 149 ) \\ \begin{matrix}{ϵ}_{s} \leq \frac{ϵ Δ}{\begin{matrix}15 {M}_{1} {‖ a ‖}_{1} {σ}_{m} {π ( {n}_{h} + log ( {M}_{1} Λ \text{/} ϵ ) )}^{2} \\ log ( ( {n}_{n} \text{/} 2 ) + log ( {M}_{1} Λ \text{/} ϵ ) \text{/} 2 )\end{matrix}} \\ \leq \frac{ϵ Δ}{15 {M}_{1} {‖ a ‖}_{1} {σ}_{m} π {μ}^{2} log ( μ \text{/} 2 )}\end{matrix} & ( 150 )\end{matrix}$$

Operationalising.

In the following two established subroutines are used, namely sample based Hamiltonian simulation (aka the LMR protocol) [5], as well as the Hadamard test, in order to evaluate the gradient approximation as defined in Eq. 105. In order to hence derive the query complexity for this algorithm, it is necessary only to multiply the cost of the number of factors we need to evaluate with the query complexity of these routines. For this the following result is relied upon.

Theorem 3.

Sample based Hamiltonian simulation [6]] Let 0≤ϵₕ≤⅙ be an error parameter and let ρ be a density for which multiple copies are obtained through queries to a oracle O_{ρ}. It is now possible to simulate the time evolution e^{-iρt} up to error ϵₕ in trace norm as long as ϵₕ/t≤1/(6π) with Θ(t²/ϵₕ) copies of ρ and hence queries to O_{ρ}.

Needed particularly are terms of the form

$$Tr [ ρ {e}^{\frac{is π m}{2} {σ}_{υ}} {e}^{\frac{i π {m}^{′}}{2} {σ}_{υ} ( {θ}_{j} )} {e}^{\frac{i ( 1 - s ) π m}{2} {σ}_{υ}} ] \qquad ( 151 )$$

Note that it is possible to simulate every term in the trace (except ρ) via the sample based Hamiltonian simulation approach to error ϵₕ in trace norm. This will introduce a additional error which must be taken into account for the analysis. Let Ũᵢ, i∈{1,2,3} be the unitaries such that ∥Uᵢ−Ũᵢ∥_{*}≤ϵₕ where the Uᵢ are corresponding to the factors in Eq. 151, i.e.,

$${U}_{1} := {e}^{\frac{i s π m}{2} {σ}_{υ}} , {U}_{2} := {e}^{\frac{i π {m}^{′}}{2} {σ}_{υ} ( {θ}_{j} )} , and {U}_{3} := {e}^{\frac{i ( 1 - s ) π m}{2} {σ}_{υ}} .$$

The error is now bounded as follows. First note that ∥Ũᵢ∥≤∥Ũᵢ−Uᵢ∥+∥Uᵢ∥≤1+ϵₕ, using Theorem 3 and the fact that the spectral norm is upper bounded by the trace norm.

Tr[ρU₁U₂U₃]−Tr[ρŨ₁Ũ₂Ũ₃]=Tr[ρU₁U₂U₃−ρŨ₁Ũ₂Ũ₃]≤∥U₁U₂U₃−Ũ₁Ũ₂Ũ₃∥≤∥U₁−Ũ₁∥∥Ũ₂∥∥Ũ₃∥+∥U₂−Ũ₂∥Ũ₃+∥U₃−Ũ₃∥≤∥U₁−Ũ₁∥_{*}(1+ϵₕ)²+∥U₂−Ũ₂∥_{*}(1+ϵₕ)+∥U₃−Ũ₃∥_{*}≤ϵₕ(1+ϵₕ)²+ϵₕ(1+ϵₕ)+ϵₕ=O(ϵₕ), (152)

neglecting higher orders of ϵₕ, and where in the first step the Von-Neumann trace inequality is applied, as well as the fact that ρ is Hermitian. In the last step, moreover, the results of Theorem 3 are used.

One now requires O((max{M₁,M₂}π)²/ϵₕ) queries to the oracles for σᵥ for the evaluation of each term in the multi sum in Eq. 105. Note that the Hadamard test has a query cost of O(1). In order to hence achieve an overall error of ϵ in the gradient estimation, the error introduced by the sample based Hamiltonian simulation must also be of O(e). Therefore, it is required that

$${ϵ}_{h} \leq O ( \frac{ϵ Δ}{5 {‖ a ‖}_{1} {M}_{1} π {μ}^{2} log ( μ \text{/} 2 )} ) ,$$

similar to the sample based error which yield the query complexity of

$$O ( \frac{max {\{ {M}_{1} , {M}_{2} \}}^{2} {‖ a ‖}_{1} {M}_{1} {π}^{3} {μ}^{2} log ( μ \text{/} 2 )}{ϵ Δ} ) \qquad ( 153 )$$

Adjusting the constants gives then the required bound of ϵ of the total error and the query complexity for the algorithm to the Gibbs state preparation procedure is consequentially given by the number of terms in Eq. 105 times the query complexity for the individual term, yielding

$$O ( \frac{{M}_{1}^{2} {M}_{2} max {\{ {M}_{1} , {M}_{2} \}}^{2} {‖ a 〛}_{1} {σ}_{m} {π}^{3} {μ}^{3} log ( \frac{μ}{2} )}{ϵ {ϵ}_{s}^{2} Δ} ) , \qquad ( 154 )$$

and classical precomputation polynomial in M₁, M₂, K₁, L, s, Δ, μ, where the different quantities are defined in Eq. 143-150.
Taking into account the query complexity of the individual steps then results in the following theorem.

Theorem 4.

Let ρ, σᵥ being two density matrices, ∥σᵥ∥<1/π, and we have access to an oracle O_{H} for the d-sparse Hamiltonian H(θ) and an oracle O_{ρ} which returns copies of purified density matrix of the data ρ, and ϵ∈(0, ⅙) an error parameter. With probability at least ⅔ an estimate [symbol] of the gradient w.r.t. θ∈ [symbol] ^{D} of the relative entropy ∇_{θ}Tr [ρ log σᵥ] is obtained, such that

∥∇_{θ}Tr[ρ log σᵥ]− [symbol] ∥ₘₐₓ≤ϵ, (155)

with

$$\tilde{O} ( \sqrt{\frac{N}{z}} \frac{D ‖ H ( θ ) ‖ d {μ}^{5} γ}{{ϵ}^{3}} ) , \qquad ( 156 )$$

queries to O_{H} and O_{ρ}, where μ∈O(nₕ+log(1/ϵ)), ∥∂_{θ}σᵥ∥≤e^{γ}, ∥σᵥ∥≥2⁻ⁿ^{ᵥ} for nᵥ being the number of visible units and nₕ being the number of hidden units, and

Õ(poly(γ,nᵥ,nₕ,log(1/ϵ))) (157)

classical precomputation.

Proof.

The runtime follows straightforwardly by using the bounds derived in Eq. 153 and Lemma 5, and by using the bounds for the parameters M₁, M₂, K₁, L, μ, Δ, s given in Eq. (143-150). For the success probability for estimating the whole gradient with dimensionality d, it is now possible to again make use of the boosting scheme used in Eq. 61 to be

$$\tilde{O} ( \frac{d {‖ a ‖}_{1}^{3} {σ}_{m}^{3} {μ}^{5} {log}^{3} ( μ \text{/} 2 ) poly {log}^{( \frac{‖ \frac{\partial σ v}{\partial θ} ‖}{ϵ} , \frac{{n}_{h}^{2} {‖ a ‖}_{1} {σ}_{m}}{ϵ Δ} )}}{{ϵ}^{3} {Δ}^{3}} log ( d ) ) , \qquad ( 158 )$$

where μ=nₕ+log(M₁Λ/ϵ).

Next it is necessary to take into account the errors from the Gibbs state preparation given in Lemma 3. For this note that the error between the perfect Hamiltonian simulation of σᵥ and the sample based Hamiltonian simulation with an erroneous density matrix denoted by Ũ, i.e., including the error from the Gibbs state preparation procedure, is given by

∥Ũ−e^{-iσ}^{ᵥ}^{t}∥≤∥Ũ−e^{-i\tilde{σ}}^{ᵥ}^{t}∥+∥e^{-i\tilde{σ}}^{ᵥ}^{t}−e^{-iσ}^{ᵥ}^{t}∥≤ϵₕ+ϵ_{G}t (159)

where ϵₕ is the error of the sample based Hamiltonian simulation, which holds since the trace norm is an upper bound for the spectral norm, and ∥σᵥ−\tilde{σ}ᵥ∥≤ϵ_{G} is the error for the Gibbs state preparation from Theorem 1 for a d-sparse Hamiltonian, for a cost

$$\tilde{𝒪} ( \sqrt{\frac{N}{z}} ‖ H ‖ d log ( \frac{‖ H ‖}{{ϵ}_{G}} ) log ( \frac{1}{{ϵ}_{G}} ) ) . \qquad ( 160 )$$

From Eq. 152 it is known that the error ϵₕ propagates nearly linear, and hence it suffices for us to take ϵ_{G}≤ϵₕ/t where t=O(max{M₁, M₂}) and adjust the constants ϵₕ−ϵₕ/2 in order to achieve the same precision ϵ in the final result. It is now required that

$$\tilde{𝒪} ( \sqrt{\frac{N}{z}} ‖ H ( θ ) ‖ log ( \frac{\begin{matrix}‖ H ( θ ) ‖ \\ max \{ {M}_{1} , {M}_{2} \}\end{matrix}}{{ϵ}_{h}} ) log ( \frac{max \{ {M}_{1} , {M}_{2} \}}{{ϵ}_{h}} ) ) \qquad ( 161 )$$

and using the ϵₕ from before we hence find that this s bound by

$$\tilde{𝒪} ( \sqrt{\frac{N}{z}} ‖ H ( θ ) ‖ log ( \frac{‖ H ( θ ) ‖ {n}_{h}^{2}}{ϵΔ} ) log ( \frac{{n}_{h}^{2}}{ϵΔ} ) ) \qquad ( 162 )$$

query complexity to the oracle of H for the Gibbs state preparation.

The procedure succeeds with probability at least 1−δₛ for a single repetition for each entry of the gradient. In order to have a failure probability of the final algorithm of less than ⅓, it is necessary to repeat the procedure for all D dimensions of the gradient and take for each the median over a number of samples. Let n_{f} be as previously the number of instances of the one component of the gradient such that the error is larger than ϵₛσₘ and nₛ be the number of instances with an error ≤ϵₛσₘ, and the result taken is the median of the estimates, where n=nₛ+n_{f} samples are collected. The algorithm gives a wrong answer for each dimension if

$${n}_{s} \leq ⌊ \frac{n}{2} ⌋ ,$$

since then the median is a sample such that the error is larger than ϵₛσₘ. Let p=1−δₛ be the success probability to draw a positive sample, as is the case of the algorithm. Since each instance of(recall that each sample here consists of a number of samples itself) from the algorithm will independently return an estimate for the entry of the gradient, the total failure probability is bounded by the union bound, i.e.,

$$P {r}_{f a i l} \leq D \cdot Pr [ {n}_{s} \leq ⌊ \frac{n}{2} ⌋ ] \leq D \cdot {{e}^{- \frac{n}{2 ( 1 - {δ}_{s} )} ( ( 1 - {δ}_{s} ) - \frac{1}{2} )}}^{2} \leq \frac{1}{3} , \qquad ( 163 )$$

which follows from the Chernoff inequality for a binomial variable with 1−δₛ>½, which is given in the present case for a proper choice of δₛ<½. Therefore, by taking

$$n \geq \frac{2 - 2 {δ}_{s}}{{( 1 \text{/} 2 - {δ}_{s} )}^{2}} log ( 3 D ) = O ( log ( 3 D ) ) ,$$

a total failure probability of at least ⅓ is achieved for a constant, fixed δₛ. Note that this for a constant, fixed. Note that this hence results in an multiplicative factor of O(log(D)) in the query complexity of Eq. 156.
The total query complexity to the oracle O_{ρ} for a purified density matrix of the data ρ and the Hamiltonian oracle O_{H} is then given by

$$\tilde{O} ( \sqrt{\frac{N}{z}} \frac{( \begin{matrix}d log ( d ) ‖ H ( θ ) ‖ {‖ a ‖}_{1}^{3} {σ}_{m}^{3} {μ}^{5} {log}^{3} ( μ \text{/} 2 ) \\ poly log \frac{‖ \frac{\partial {σ}_{υ}}{\partial θ} ‖}{ϵ} , \frac{{n}_{h}^{2} {‖ a ‖}_{1} {σ}_{m}}{ϵ Δ} , ‖ H ( θ ) ‖\end{matrix} )}{{ϵ}^{3} {Δ}^{3}} ) , \qquad ( 164 )$$

which reduces to

$$\tilde{O} ( \sqrt{\frac{N}{z}} \frac{D ‖ H ( θ ) ‖ d {μ}^{5} α}{{ϵ}^{3}} ) , \qquad ( 165 )$$

hiding the logarithmic factors in the Õ notation.

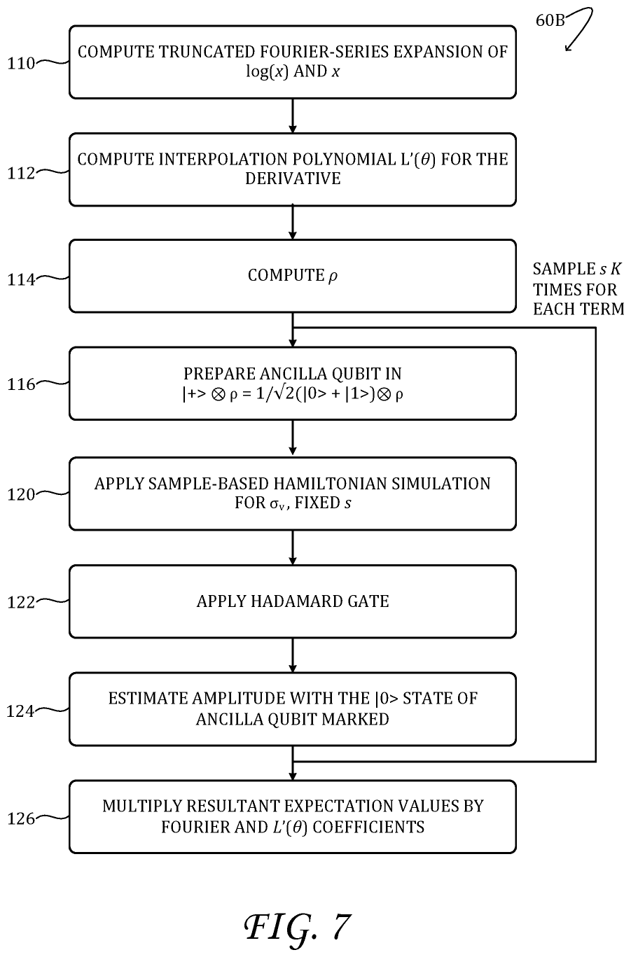

Returning once again to the drawings, FIG. 7 illustrates an example method 60B to estimate the gradient of the quantum relative entropy of a restricted or non-restricted QBM having visible and hidden nodes. Method 60B may be employed as a particular instance of step 60 in training method of FIG. 5. Each step of this method is developed in detail in the description above; accordingly, the present description provides only summary detail to enable the reader to understand the process flow in one non-limiting example.

In this method, the gradient of the quantum relative entropy is estimated based on one or more high-order divided-difference formulas. At 110 of method 60B, truncated Fourier-series expansions of log(x) and x are computed. At 112 an interpolation polynomial L′(θ) is computed to represent a derivative that appears in the gradient of the quantum relative entropy. At 114 the density operator ρ is computed.

At 116 of method 60B, a control loop is encountered wherein an ancilla qubit is prepared in the state |+ [symbol] ⊗ρ=1/\sqrt{2}(|0 [symbol] +|1 [symbol] )⊗ρ. At 120, a sample-based Hamiltonian simulation is applied to provide a majorised distribution σᵥ over the one or more visible nodes at fixed s. Then, at 122, a Hadamard gate is applied. At 124, the amplitude of the ancilla qubit state is estimated with the |0 [symbol] state of the ancilla qubit marked. Accordingly, estimating based on the one or more high-order divided-difference formulas in method 60B includes using the quantum computer to compute one or more divided differences of a training objective function of the QBM using Fourier-series methods.

At each iteration through the control loop, the confidence analysis described above is applied in order to determine whether additional measurements are required to achieve precision ϵ. If so, execution returns to 116. Otherwise, the product of the expectation values and the Fourier and L′(θ) coefficients is evaluated and returned.

### Appendix for Approach 1 and Approach 2

Bounds on the Gradient.

Starting with some preliminary equations needed in order to obtain a useful bound on the gradient,

Let A(θ) be a linear operator which depends linearly on the density matrix σ. Then

$$\frac{\partial }{\partial θ} {A ( θ )}^{- 1} = - {A}^{- 1} \frac{\partial σ}{\partial θ} {A}^{- 1} . \qquad ( 166 )$$

Proof.

The proof follows straightforwardly by using the identity I.

$$\frac{\partial I}{\partial θ} = 0 = \frac{\partial }{\partial θ} A {A}^{- 1} = ( \frac{\partial A}{\partial θ} ) {A}^{- 1} + A ( \frac{\partial {A}^{- 1}}{\partial θ} ) .$$

Reordering the terms completes the proof. This can equally be proven using the Gateau derivative.

In the following one will furthermore rely on the following well-known inequality.

Lemma 7.

Von Neumann Trace Inequality. Let A∈ [symbol] ^{n×n} and B∈ [symbol] ^{n×n} with singular values {σᵢ(A)}ᵢ₌₁ⁿ and {σᵢ(B)}ᵢ₌₁ⁿ respectively such that σᵢ(⋅)≤σⱼ(⋅) if i≤j. It then holds that

$$\vert Tr [ AB ] \vert \leq {\sum }_{i = 1}^{n} {σ ( A )}_{i} {σ ( B )}_{i} . \qquad ( 167 )$$

Note that from this, one immediately obtains

$$\vert Tr [ AB ] \vert \leq {\sum }_{i = 1}^{n} {σ ( A )}_{i} {σ ( B )}_{i} \leq {σ}_{max} ( B ) {\sum }_{i} {σ ( A )}_{i} = ‖ B ‖ {\sum }_{i} {σ ( A )}_{i} . \qquad ( 168 )$$

This is particularly useful if A is Hermitian and PSD, since this implies |Tr [AB]|≤∥B∥ Tr [A] for Hermitian A.

Since dealing with operators, the common chain rule of differentiation does not hold generally. Indeed the chain rule is a special case if the derivative of the operator commutes with the operator itself. Since a term of the form log σ(θ) is encountered, one cannot assume that [σ, σ′]=0, where σ′:=σ⁽¹⁾ is the derivative w.r.t., θ. For this case the following identity is needed, similar to Duhamels formula, in the derivation of the gradient for the purely-visible-units Boltzmann machine.

Lemma 8. Derivative of Matrix Logarithm [7]

$$\frac{d}{d t} log A ( t ) = {\int }_{0}^{1} {[ s A + ( 1 - s ) I ]}^{- 1} {( \frac{d A}{d t} ) [ s A + ( 1 - s ) I ]}^{- 1} . \qquad ( 169 )$$

For completeness a proof of the above identity is now included.

Proof.

The integral definition of the logarithm [8] is used for a complex, invertible, n×n matrix A=A(t) with no real negative

log A=(A−I)∫₀¹[s(A−I)+I]⁻¹. (170)

From this is obtained the derivative

$$\frac{d}{d t} log A = \frac{d A}{d t} {\int }_{0}^{1} d {s [ s ( A - I ) + I ]}^{- 1} ( A - I ) {\int }_{0}^{1} d s {\frac{d}{d t} [ s ( A - I ) + I ]}^{- 1} . \qquad ( 171 )$$

Applying Eq. 166 to the second term on the right hand side yields

$$\frac{d}{d t} log A = \frac{d A}{d t} {\int }_{0}^{1} d {s [ s ( A - I ) + I ]}^{- 1} + ( A - I ) {\int }_{0}^{1} d {s [ s ( A - I ) + I ]}^{- 1} s {\frac{d A}{d t} [ s ( A - I ) + I ]}^{- 1} , \qquad ( 172 )$$

which can be rewritten as

$$\begin{matrix}\frac{d}{d t} log A = {\int }_{0}^{1} d {s [ s ( A - I ) + I ] [ s ( A - I ) + I ]}^{- 1} {\frac{d A}{d t} [ s ( A - I ) + I ]}^{- 1} & ( 173 ) \\ + ( A - I ) {\int }_{0}^{1} d {s [ s ( A - I ) + I ]}^{- 1} s {\frac{d A}{d t} [ s ( A - I ) + I ]}^{- 1} , & ( 174 )\end{matrix}$$

by adding the identity I=[s(A−I)+I][s(A−I)+I]⁻¹ in the first integral and reordering commuting terms (i.e., s). Notice that one can hence just subtract the first two terms in the integral which yields Eq. 169 as desired.

Amplitude Estimation.

The well known amplitude estimation algorithm can be performed via the following steps.
1. Initialize two registers of appropriate sizes to the state |0 [symbol] [symbol] |0 [symbol] , where [symbol] is a unitary transformation which prepares the input state, i.e., |ψ [symbol] = [symbol] |0 [symbol]
2. Apply the quantum Fourier transform

$${QFT}_{N} : \vert x 〉 \to \frac{1}{\sqrt{N}} {Σ}_{y = 0}^{N - 1} {e}^{2 π i x y / N} \vert y 〉$$

for 0≤x<N, to the first register.
3. Apply the controlled-Q operator to the second register, i.e., let Λ_{N}(U):|j [symbol] |y [symbol] →|j [symbol] (U^{j}|y [symbol] ) for 0≤j<N), then we apply λ_{N}(Q) where Q:=− [symbol] S₀ [symbol] ^{†}Sₜ is the Grover's operator, S₀ changes the sign of the amplitude if and only if the state is the zero state |0 [symbol] , and St is the sign-flip operator for the target state, i.e., if |x [symbol] is the desired outcome, then Sₜ:=I−2|x [symbol] [symbol] x|.
4. Apply QFT_{N}^{†} to the first register.
5. Output

$$\tilde{a} = {sin}^{2} ( π \frac{\tilde{θ}}{N} ) .$$

The algorithm can hence be summarized as the unitary transformation

((QFT†⊗I)Λ_{N}(Q)(QFT_{N}⊗I)) (175)

applied to the state |0 [symbol] [symbol] |0 [symbol] , followed by a measurement of the first register and classical post-processing returns an estimate \tilde{θ} of the amplitude of the desired outcome such that |θ−\tilde{θ}|≤ϵ with probability at least 8/π². The result is summarized in the following theorem, which states a slightly more general version.

Theorem 5.

Amplitude Estimation [9] For any positive integer k, the Amplitude Estimation Algorithm returns an estimate ã (0≤ã≤1) such that

$$\vert \tilde{a} - a \vert \leq 2 πk \frac{\sqrt{a ( 1 - a )}}{N} + {k}^{2} \frac{{π}^{2}}{{N}^{2}} \qquad ( 176 )$$

with probability at least

$$\frac{8}{{π}^{2}} \approx 0.81$$

for k=1 and with probability greater than

$$1 - \frac{1}{2 ( k - 1 )}$$

for k≥2. If a=0 then ã=0 with certainty, and if a=1 and N is even, then ã=1 with certainty.

Notice that the amplitude θ can hence be recovered via the relation θ=arcsin \sqrt{θₐ} as described above which incurs an ϵ-error for θ (c.f., Lemma 7, [9]).

### CONCLUSION AND CLAIMS

One aspect of this disclosure is directed to a method to train a QBM having one or more visible nodes and one or more hidden nodes. The method comprises associating each visible and each hidden node of the QBM to a different corresponding qubit of a plurality of qubits of a quantum computer, wherein a state of each of the plurality of qubits contributes to a global energy of the QBM according to a set of weighting factors, and wherein the plurality of qubits include one or more output qubits corresponding to one or more visible nodes of the QBM. The method further comprises providing a distribution of training data over the one or more output qubits, estimating a gradient of a quantum relative entropy between the one or more output qubits and the distribution of training data, and training the set of weighting factors based on the estimated gradient, using the quantum relative entropy as a cost function.

In some implementations, the quantum relative entropy S is defined by S(ρ|σᵥ)=Tr (ρ log ρ)−Tr (ρ log σᵥ), wherein S is a function of density operator ρ conditioned on a majorised distribution σᵥ over the one or more visible nodes, and wherein Tr is a trace of an operator. In some implementations, the QBM is a restricted QBM, in which every Hamiltonian operator acting on a qubit corresponding to a hidden node of the QBM commutes with every other Hamiltonian operator acting on a qubit corresponding to a hidden node of the QBM. In some implementations, estimating the gradient includes computing a variational upper bound on the quantum relative entropy. In some implementations, estimating the gradient includes using substantially commuting operators to assign an energy penalty to each qubit corresponding to a hidden node of the QBM. In some implementations, estimating the gradient includes preparing a purified Gibbs state in the plurality of qubits based on one or more Hamiltonians. In some implementations, estimating the gradient of the quantum relative entropy includes estimating based on one or more high-order divided-difference formulas. In some implementations, estimating based on the one or more high-order divided-difference formulas includes using the quantum computer to compute one or more divided differences of a training objective function of the QBM using Fourier-series methods. In some implementations, using the quantum computer to compute the one or more divided differences includes using the quantum computer to compute one or more truncated Fourier-series expansions. In some implementations, estimating the gradient of the quantum relative entropy includes computing an interpolation polynomial to represent a derivative appearing in the gradient. In some implementations, estimating the gradient of the quantum relative entropy includes applying a sample-based Hamiltonian simulation to provide a distribution σᵥ over the one or more visible nodes.

Another aspect of this disclosure is directed to a quantum computer comprising a register including a plurality of qubits, a modulator configured to implement one or more quantum-logic operations on the plurality of qubits, a demodulator configured to output data based on a quantum state of the plurality of qubits, a controller operatively coupled to the modulator and to the demodulator, and computer memory associated with the controller. The computer memory holds instructions that cause the controller to instantiate a QBM having one or more visible nodes and one or more hidden nodes, wherein each visible and each hidden node corresponds to a different qubit of the plurality of qubits, wherein a state of each of the plurality of qubits contributes to a global energy of the QBM according to a set of weighting factors, wherein the plurality of qubits include one or more output qubits corresponding to one or more visible nodes of the QBM, and wherein the weighting factors are trained using a distribution of training data over the one or more output qubits, based on a previously estimated gradient of a quantum relative entropy between the one or more output qubits and the distribution of training data, using the quantum relative entropy as a cost function.

In some implementations, the instructions cause the controller to estimate the gradient of the quantum relative entropy and to train the set of weighting factors based on the estimated gradient, using the quantum relative entropy as a cost function.

Another aspect of this disclosure is directed to a quantum computer comprising a register including a plurality of qubits, a modulator configured to implement one or more quantum-logic operations on the plurality of qubits, a demodulator configured to output data based on a quantum state of the plurality of qubits, a controller operatively coupled to the modulator and to the demodulator, and computer memory associated with the controller. The computer memory holds instructions that cause the controller to instantiate a QBM having one or more visible nodes and one or more hidden nodes, wherein each visible and each hidden node corresponds to a different qubit of the plurality of qubits, wherein a state of each of the plurality of qubits contributes to a global energy of the QBM according to a set of weighting factors, and wherein the plurality of qubits include one or more output qubits corresponding to one or more visible nodes of the QBM. The instructions further cause the controller to provide a distribution of training data over the one or more output qubits, estimate a gradient of a quantum relative entropy between the one or more output qubits and the distribution of training data, and train the set of weighting factors based on the estimated gradient, using the quantum relative entropy as a cost function.

In some implementations, the QBM is a restricted QBM, in which every Hamiltonian operator acting on a qubit corresponding to a hidden node of the QBM commutes with every other Hamiltonian operator acting on a qubit corresponding to a hidden node of the QBM, and estimation of the gradient includes computation of a variational upper bound on the quantum relative entropy. In some implementations, estimation of the gradient includes use of substantially commuting operators to assign an energy penalty to each qubit corresponding to a hidden node of the QBM. In some implementations, estimation of the gradient includes preparation of a purified Gibbs state in the plurality of qubits based on one or more Hamiltonians. In some implementations, the gradient of the quantum relative entropy is estimated based on one or more high-order divided-difference formulas, and estimation of the gradient based on the one or more divided-difference formulas includes using the quantum computer to compute one or more divided differences of a training objective function of the QBM using Fourier-series methods. In some implementations, estimation of the gradient includes computation of an interpolation polynomial to represent a derivative appearing in the gradient. In some implementations, estimation of the gradient includes applying a sample-based Hamiltonian simulation to provide a distribution σᵥ over the one or more visible nodes.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method to train a quantum Boltzmann machine (QBM) having one or more visible nodes and one or more hidden nodes, the method comprising:
associating each visible and each hidden node of the QBM to a different corresponding qubit of a plurality of qubits of a quantum computer, wherein a state of each of the plurality of qubits contributes to a global energy of the QBM according to a set of weighting factors, and wherein the plurality of qubits include one or more output qubits corresponding to one or more visible nodes of the QBM;
providing a distribution of training data over the one or more output qubits;
estimating a gradient of a quantum relative entropy between the one or more output qubits and the distribution of training data; and
training the set of weighting factors based on the estimated gradient, using the quantum relative entropy as a cost function.

2. The method of claim 1 wherein the quantum relative entropy S is defined by S(ρ|σᵥ)=Tr (ρ log ρ)−Tr (ρ log σᵥ), wherein S is a function of density operator ρ conditioned on a majorised distribution σᵥ over the one or more visible nodes, and wherein Tr is a trace of an operator.

3. The method of claim 1 wherein the QBM is a restricted QBM, in which every Hamiltonian operator acting on a qubit corresponding to a hidden node of the QBM commutes with every other Hamiltonian operator acting on a qubit corresponding to a hidden node of the QBM.

4. The method of claim 3 wherein estimating the gradient includes computing a variational upper bound on the quantum relative entropy.

5. The method of claim 3 wherein estimating the gradient includes using substantially commuting operators to assign an energy penalty to each qubit corresponding to a hidden node of the QBM.

6. The method of claim 3 wherein estimating the gradient includes preparing a purified Gibbs state in the plurality of qubits based on one or more Hamiltonians.

7. The method of claim 1 wherein estimating the gradient of the quantum relative entropy includes estimating based on one or more high-order divided-difference formulas.

8. The method of claim 7 wherein estimating based on the one or more high-order divided-difference formulas includes using the quantum computer to compute one or more divided differences of a training objective function of the QBM using Fourier-series methods.

9. The method of claim 8 wherein using the quantum computer to compute the one or more divided differences includes using the quantum computer to compute one or more truncated Fourier-series expansions.

10. The method of claim 1 wherein estimating the gradient of the quantum relative entropy includes computing an interpolation polynomial to represent a derivative appearing in the gradient.

11. The method of claim 1 wherein estimating the gradient of the quantum relative entropy includes applying a sample-based Hamiltonian simulation to provide a distribution σᵥ over the one or more visible nodes.

12. A quantum computer comprising:
a register including a plurality of qubits;
a modulator configured to implement one or more quantum-logic operations on the plurality of qubits;
a demodulator configured to output data based on a quantum state of the plurality of qubits;
a controller operatively coupled to the modulator and to the demodulator; and
associated with the controller, computer memory holding instructions that cause the controller to:
instantiate a quantum Boltzmann machine (QBM) having one or more visible nodes and one or more hidden nodes, wherein each visible and each hidden node corresponds to a different qubit of the plurality of qubits, wherein a state of each of the plurality of qubits contributes to a global energy of the QBM according to a set of weighting factors, and wherein the plurality of qubits include one or more output qubits corresponding to one or more visible nodes of the QBM, and
wherein the weighting factors are trained using a distribution of training data over the one or more output qubits, based on a previously estimated gradient of a quantum relative entropy between the one or more output qubits and the distribution of training data, using the quantum relative entropy as a cost function.

13. The quantum computer of claim 12 wherein the instructions cause the controller to estimate the gradient of the quantum relative entropy and to train the set of weighting factors based on the estimated gradient, using the quantum relative entropy as a cost function.

14. A quantum computer comprising:
a register including a plurality of qubits;
a modulator configured to implement one or more quantum-logic operations on the plurality of qubits;
a demodulator configured to reveal data based on a quantum state of the plurality of qubits;
a controller operatively coupled to the modulator and to the demodulator; and
associated with the controller, computer memory holding the stored control-parameter values and holding instructions that cause the controller to:
instantiate a quantum Boltzmann machine (QBM) having one or more visible nodes and one or more hidden nodes, wherein each visible and each hidden node corresponds to a different qubit of the plurality of qubits, wherein a state of each of the plurality of qubits contributes to a global energy of the QBM according to a set of weighting factors, and wherein the plurality of qubits include one or more output qubits corresponding to one or more visible nodes of the QBM,
provide a distribution of training data over the one or more output qubits;
estimate a gradient of a quantum relative entropy between the one or more output qubits and the distribution of training data, and
train the set of weighting factors based on the estimated gradient, using the quantum relative entropy as a cost function.

15. The quantum computer of claim 14 wherein the QBM is a restricted QBM, in which every Hamiltonian operator acting on a qubit corresponding to a hidden node of the QBM commutes with every other Hamiltonian operator acting on a qubit corresponding to a hidden node of the QBM, and wherein estimation of the gradient includes computation of a variational upper bound on the quantum relative entropy.

16. The quantum computer of claim 15 wherein estimation of the gradient includes use of substantially commuting operators to assign an energy penalty to each qubit corresponding to a hidden node of the QBM.

17. The quantum computer of claim 15 wherein estimation of the gradient includes preparation of a purified Gibbs state in the plurality of qubits based on one or more Hamiltonians.

18. The quantum computer of claim 14 wherein the gradient of the quantum relative entropy is estimated based on one or more high-order divided-difference formulas, and wherein estimation of the gradient based on the one or more divided-difference formulas includes using the quantum computer to compute one or more divided differences of a training objective function of the QBM using Fourier-series methods.

19. The quantum computer of claim 18 wherein estimation of the gradient includes computation of an interpolation polynomial to represent a derivative appearing in the gradient.

20. The quantum computer of claim 18 wherein estimation of the gradient includes applying a sample-based Hamiltonian simulation to provide a distribution σᵥ over the one or more visible nodes.
